(19) United States
(12) Patent Application Publication
(10) Pub. No.: US 2026/0155944 A1
(43) Pub. Date: Jun. 4, 2026

(54) INTERLACED SEARCH SPACE CONFIGURATION FOR REFERENCE SIGNAL SHARING WITHIN A WIRELESS COMMUNICATIONS SYSTEM

(71) Applicant: QUALCOMM Incorporated, San Diego, CA (US)

(72) Inventors: Chih-Hao LIU, San Diego, CA (US); Jing SUN, San Diego, CA (US); Morteza SOLTANI, San Diego, CA (US)

(21) Appl. No.: 18/967,031

(22) Filed: Dec. 3, 2024

(51) Int. Cl. H04L 5/00; H04L 27/26; H04W 72/23

(52) U.S. Cl. CPC H04L 5/0094; H04L 27/261; H04W 72/23

(57) ABSTRACT

Methods, systems, and devices for wireless communications are described. A user equipment (UE) may receive control signaling indicating a control channel configuration for reference signal sharing across a group of UEs. The control channel configuration may indicate a sub-resource element group (REG) bundle interlaced search space associated with an interlaced set of control channel elements (CCEs) and offsets for mapping downlink control channel candidates to the interlaced set of CCEs in accordance with the reference signal sharing across the group of UEs. The UE may monitor, in target CCEs of the interlaced set of CCEs in accordance with at least one offset, for at least one target downlink control channel associated with the UE. The UE may receive reference signals in accordance with the monitoring.

### FIELD OF TECHNOLOGY

The following relates to wireless communications, including interlaced search space configuration for reference signal sharing within a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a control channel configuration for reference signal sharing across a group of UEs including at least the UE, where the control channel configuration indicates a sub-resource element group (REG) bundle interlaced search space associated with an interlaced set of control channel elements (CCEs) and indicates one or more offsets for mapping one or more downlink control channel candidates to the interlaced set of CCEs in accordance with the reference signal sharing across the group of UEs, monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE, and receiving, at the one or more target CCEs, one or more reference signals in accordance with monitoring for the at least one target downlink control channel.

A UE for wireless communications is described. The UE may include one or more memories storing processor executable code, and one or more processors coupled with the one or more memories. The one or more processors may individually or collectively be operable to execute the code to cause the UE to receive control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs, monitor, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE, and receive, at the one or more target CCEs, one or more reference signals in accordance with monitoring for the at least one target downlink control channel.

Another UE for wireless communications is described. The UE may include means for receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs, means for monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE, and means for receiving, at the one or more target CCEs, one or more reference signals in accordance with monitoring for the at least one target downlink control channel.

A non-transitory computer-readable medium storing code for wireless communications is described. The code may include instructions executable by one or more processors to receive control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs, monitor, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE, and receive, at the one or more target CCEs, one or more reference signals in accordance with monitoring for the at least one target downlink control channel.

Some examples of the method, UEs, and non-transitory computer-readable medium described herein may further include operations, features, means, or instructions for mapping the one or more downlink control channel candidates to the interlaced set of CCEs in accordance with a CCE group index, a CCE index, or both, and in accordance with the one or more offsets, where the one or more target CCEs may be monitored in accordance with mapping the one or more downlink control channel candidates to the interlaced set of CCEs.

Some examples of the method, UEs, and non-transitory computer-readable medium described herein may further include operations, features, means, or instructions for mapping the one or more downlink control channel candidates to a set of multiple sets of CCEs in accordance with the one or more offsets, an aggregation level, or both, where the set of multiple sets of CCEs includes at least the interlaced set of CCEs and where the one or more target CCEs may be monitored in accordance with mapping the one or more downlink control channel candidates to the set of multiple sets of CCEs.

In some examples of the method, UEs, and non-transitory computer-readable medium described herein, a quantity of sets of CCEs in the set of multiple sets of CCEs may be in accordance with the aggregation level.

In some examples of the method, UEs, and non-transitory computer-readable medium described herein, the one or more downlink control channel candidates include a quantity of downlink control channel candidates, the quantity of downlink control channel candidates in accordance with a quantity of sets of CCEs within the set of multiple sets of CCEs.

In some examples of the method, UEs, and non-transitory computer-readable medium described herein, the control channel configuration indicates that each downlink control channel candidate of the one or more downlink control channel candidates may be associated with a respective consecutive index.

Some examples of the method, UEs, and non-transitory computer-readable medium described herein may further include operations, features, means, or instructions for mapping the one or more downlink control channel candidates to the interlaced set of CCEs in accordance with the respective consecutive index and a quantity of groups of CCEs in the interlaced set of CCEs, where the one or more target CCEs may be monitored in accordance with mapping the one or more downlink control channel candidates to the interlaced set of CCEs.

Some examples of the method, UEs, and non-transitory computer-readable medium described herein may further include operations, features, means, or instructions for mapping the one or more downlink control channel candidates to the interlaced set of CCEs in accordance with the respective consecutive index and a respective interlace index, the respective interlace index indicated in the control channel configuration, where the one or more target CCEs may be monitored in accordance with mapping the one or more downlink control channel candidates to the interlaced set of CCEs.

In some examples of the method, UEs, and non-transitory computer-readable medium described herein, the control channel configuration indicates that each downlink control channel candidate of the one or more downlink control channel candidates may be associated with a respective leading CCE associated with a respective leading CCE index and each downlink control channel candidate of the one or more downlink control channel candidates may be associated with a respective CCE index in accordance with the leading CCE index.

Some examples of the method, UEs, and non-transitory computer-readable medium described herein may further include operations, features, means, or instructions for mapping the one or more downlink control channel candidates to the interlaced set of CCEs in accordance with the respective leading CCE index and a quantity of CCEs in the interlaced set of CCEs, where the one or more target CCEs may be monitored in accordance with mapping the one or more downlink control channel candidates to the interlaced set of CCEs.

Some examples of the method, UEs, and non-transitory computer-readable medium described herein may further include operations, features, means, or instructions for mapping the one or more downlink control channel candidates to the interlaced set of CCEs in accordance with a quantity of CCEs in the interlaced set of CCEs and a quantity of groups of CCEs in the interlaced set of CCEs, where the one or more target CCEs may be monitored in accordance with mapping the one or more downlink control channel candidates to the interlaced set of CCEs.

In some examples of the method, UEs, and non-transitory computer-readable medium described herein, the UE may be co-located with one or more other UEs of the group of UEs and the one or more offsets may be in accordance with the co-location.

In some examples of the method, UEs, and non-transitory computer-readable medium described herein, a first subset of downlink control channel candidates of the one or more downlink control channel candidates may share a common demodulation reference signal (DMRS) sequence associated with a shared DMRS and receiving the one or more reference signals may include operations, features, means, or instructions for receiving the shared DMRS via at least one downlink control channel candidate of the first subset of downlink control channel candidates.

A method for wireless communications by a network entity is described. The method may include outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs and outputting, at one or more target CCEs of the interlaced set of CCEs, one or more reference signals in accordance with the control channel configuration.

A network entity for wireless communications is described. The network entity may include one or more memories storing processor executable code, and one or more processors coupled with the one or more memories. The one or more processors may individually or collectively be operable to execute the code to cause the network entity to output control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs and output, at one or more target CCEs of the interlaced set of CCEs, one or more reference signals in accordance with the control channel configuration.

Another network entity for wireless communications is described. The network entity may include means for outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs and means for outputting, at one or more target CCEs of the interlaced set of CCEs, one or more reference signals in accordance with the control channel configuration.

A non-transitory computer-readable medium storing code for wireless communications is described. The code may include instructions executable by one or more processors to output control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs and output, at one or more target CCEs of the interlaced set of CCEs, one or more reference signals in accordance with the control channel configuration.

Some examples of the method, network entities, and non-transitory computer-readable medium described herein may further include operations, features, means, or instructions for mapping the one or more downlink control channel candidates to the interlaced set of CCEs in accordance with a CCE group index, a CCE index, or both, in accordance with the one or more offsets, where outputting the one or more reference signals at the one or more target CCEs may be in accordance with mapping the one or more downlink control channel candidates to the interlaced set of CCEs.

Some examples of the method, network entities, and non-transitory computer-readable medium described herein may further include operations, features, means, or instructions for mapping the one or more downlink control channel candidates to a set of multiple sets of CCEs in accordance with the one or more offsets, an aggregation level, or both, where the set of multiple sets of CCEs includes at least the interlaced set of CCEs, where outputting the one or more reference signals at the one or more target CCEs may be in accordance with mapping the one or more downlink control channel candidates to the set of multiple sets of CCEs.

In some examples of the method, network entities, and non-transitory computer-readable medium described herein, a quantity of sets of CCEs within the set of multiple sets of CCEs may be in accordance with the aggregation level.

In some examples of the method, network entities, and non-transitory computer-readable medium described herein, the one or more downlink control channel candidates include a quantity of downlink control channel candidates, the quantity of downlink control channel candidates in accordance with a quantity of sets of CCEs within the set of multiple sets of CCEs.

In some examples of the method, network entities, and non-transitory computer-readable medium described herein, the control channel configuration indicates that each downlink control channel candidate of the one or more downlink control channel candidates may be associated with a respective consecutive index.

Some examples of the method, network entities, and non-transitory computer-readable medium described herein may further include operations, features, means, or instructions for mapping the one or more downlink control channel candidates to the interlaced set of CCEs in accordance with the respective consecutive index and a quantity of groups of CCEs in the interlaced set of CCEs, where outputting the one or more reference signals at the one or more target CCEs may be in accordance with mapping the one or more downlink control channel candidates to the interlaced set of CCEs.

Some examples of the method, network entities, and non-transitory computer-readable medium described herein may further include operations, features, means, or instructions for mapping the one or more downlink control channel candidates to the interlaced set of CCEs in accordance with the respective consecutive index and a respective interlace index, the respective interlace index indicated in the control channel configuration, where outputting the one or more reference signals at the one or more target CCEs may be in accordance with mapping the one or more downlink control channel candidates to the interlaced set of CCEs.

In some examples of the method, network entities, and non-transitory computer-readable medium described herein, outputting the one or more reference signals may include operations, features, means, or instructions for outputting, via at least one downlink control channel candidate, the one or more reference signals to the group of UEs in accordance with the control channel configuration mapping the at least one downlink control channel candidate to the interlaced set of CCEs.

In some examples of the method, network entities, and non-transitory computer-readable medium described herein, each downlink control channel candidate of the one or more downlink control channel candidates may be associated with a respective leading CCE index in accordance with the leading CCE index.

Some examples of the method, network entities, and non-transitory computer-readable medium described herein may further include operations, features, means, or instructions for mapping the one or more downlink control channel candidates to the interlaced set of CCEs in accordance with a quantity of CCEs in the interlaced set of CCEs and a quantity of groups of CCEs in the interlaced set of CCEs, where outputting the one or more reference signals at the one or more target CCEs may be in accordance with mapping the one or more downlink control channel candidates to the interlaced set of CCEs.

Some examples of the method, network entities, and non-transitory computer-readable medium described herein may further include operations, features, means, or instructions for mapping the one or more downlink control channel candidates to the interlaced set of CCEs in accordance with the respective leading CCE index and a quantity of CCEs in the interlaced set of CCEs, where outputting the one or more reference signals at the one or more target CCEs may be in accordance with mapping the one or more downlink control channel candidates to the interlaced set of CCEs.

In some examples of the method, network entities, and non-transitory computer-readable medium described herein, outputting the one or more reference signals may include operations, features, means, or instructions for outputting, via at least one downlink control channel candidate, the one or more reference signals to the group of UEs in accordance with the mapping associated with the respective leading CCE.

In some examples of the method, network entities, and non-transitory computer-readable medium described herein, a UE of the group of UEs may be co-located with one or more other UEs of the group of UEs and the one or more offsets may be in accordance with the co-location.

In some examples of the method, network entities, and non-transitory computer-readable medium described herein, a first subset of downlink control channel candidates of the one or more downlink control channel candidates share a common DMRS sequence associated with a shared DMRS and outputting the one or more reference signals may include operations, features, means, or instructions for outputting the shared DMRS via at least one downlink control channel candidate of the first subset of downlink control channel candidates.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support interlaced search space configuration for reference signal sharing within a wireless communications system in accordance with one or more aspects of the present disclosure.

FIGS. 3 and 4 show examples of mapping diagrams that support interlaced search space configuration for reference signal sharing within a wireless communications system in accordance with one or more aspects of the present disclosure.

FIG. 5 shows an example of a process flow that supports interlaced search space configuration for reference signal sharing within a wireless communications system in accordance with one or more aspects of the present disclosure.

FIGS. 6 and 7 show block diagrams of devices that support interlaced search space configuration for reference signal sharing within a wireless communications system in accordance with one or more aspects of the present disclosure.

FIG. 8 shows a block diagram of a communications manager that supports interlaced search space configuration for reference signal sharing within a wireless communications system in accordance with one or more aspects of the present disclosure.

FIG. 9 shows a diagram of a system including a device that supports interlaced search space configuration for reference signal sharing within a wireless communications system in accordance with one or more aspects of the present disclosure.

FIGS. 10 and 11 show block diagrams of devices that support interlaced search space configuration for reference signal sharing within a wireless communications system in accordance with one or more aspects of the present disclosure.

FIG. 12 shows a block diagram of a communications manager that supports interlaced search space configuration for reference signal sharing within a wireless communications system in accordance with one or more aspects of the present disclosure.

FIG. 13 shows a diagram of a system including a device that supports interlaced search space configuration for reference signal sharing within a wireless communications system in accordance with one or more aspects of the present disclosure.

FIGS. 14 through 16 show flowcharts illustrating methods that support interlaced search space configuration for reference signal sharing within a wireless communications system in accordance with one or more aspects of the present disclosure.

### DETAILED DESCRIPTION

In some wireless communications systems, a network entity may schedule physical downlink control channels (PDCCHs) for multiple user equipments (UEs) at once through reference signal sharing. Reference signal sharing may reduce signaling and latency, while improving channel diversity, among other benefits. A UE may be associated with a control channel element (CCE) group that may be divided into different resource-element groups (REGs), or a REG bundle. In some cases, the REGs for a CCE group may be grouped into sub-groups (e.g., sub-REG bundles), such as one sub-REG bundle per CCE within a CCE group. A control channel (e.g., a physical downlink control channel (PDCCH)) may span sub-REG bundle. The sub-REG bundles for a CCE associated with one UE may be interlaced with sub-REG bundles of CCEs for other UEs, such as co-located UEs. The REGs may be mapped to continuous resource blocks, but may be interlaced such that one sub-REG bundle for a UE may be in a CCE group next to a sub-REG bundle for another UE in the CCE group. These resource blocks may be mapped to different reference signals, allowing multiple UEs to share a reference signal, which may span multiple sub-REG bundles. For example, a REG bundle may include six REGs. In one example, a UE may group three of the REGs, creating two sub-REG bundles, which may be interlaced with sub-REG bundles of CCEs for another UE. A reference signal may span two interlaced sub-REG bundles (e.g., a sub-REG bundle from the UE and a sub-REG bundle from the other UE).

The interlacing of REG bundles and sub-REG bundles may be defined by an interlace index and, in some cases, a group index, which may be applied to the different CCEs associated with the sub-REG bundles such that interlaced sub-groups refer to the same CCE groups (via the group index) and have corresponding interlace indices within the CCE group. In some implementations, PDCCH candidates may be mapped to the interlaced CCEs. UEs may monitor the respective CCEs for PDCCHs that may schedule reference signals. In order to support DMRS sharing, the PDCCH candidates for co-located UEs, which may share reference signals to improve frequency diversity, may be mapped to the same interlaced CCE groups, or to consecutive interlaced CCEs. However, the network entity may be operable to ensure that co-located UEs are mapped to the same CCE group (e.g., are interlaced with each other), which may reduce throughput and frequency diversity, among other examples.

The techniques described herein provide for a mapping between CCE groups and control channel candidates (which may span the REG sub-groups) to support reference signal sharing. For example, a network entity may configure a group of UEs to support an interlaced search space associated with CCEs and may also indicate offsets for mapping PDCCH candidates to the interlaced CCEs in order to support reference signal sharing, particularly between co-located UEs. A UE may monitor target PDCCHs at target CCEs within the interlaced search space based on the offsets and may receive reference signals via the interlaced search space and the target PDCCH. In some cases, the CCEs may be consecutively grouped into the CCE groups. The PDCCH candidates may be consecutively indexed to support interlacing based on the offsets, and may be grouped together into CCE groups in accordance with the interlacing indices. That is, the PDCCH candidates associated with one UE may not have consecutive indices because they may be interlaced with other PDCCH candidates within the CCE group. Additionally, or alternatively, the PDCCH candidates may be grouped together based on the offsets, and may be interlaced accordingly. That is, the PDCCH candidates associated with one UE may have consecutive indices, and may be interlaced according to the offsets. In some cases, the PDCCH candidates may be mapped to the CCE groups using a two-step process. A PDCCH candidate to CCE mapping may be used to define an “anchor” CCE that may be the first CCE in the group, and the other CCEs may be mapped to the group based on the anchor CCE. After interlacing, the network entity may transmit a reference signal to one CCE group via the PDCCHs. The reference signal may be a demodulation reference signal (DMRS), or some other type of reference signal (e.g., DMRS sharing).

Aspects of the disclosure are initially described in the context of wireless communications systems, mapping diagrams, and process flows. Aspects of the disclosure are further illustrated by and described with reference to apparatus diagrams, system diagrams, and flowcharts that relate to interlaced search space configuration for reference signal sharing within a wireless communications system.

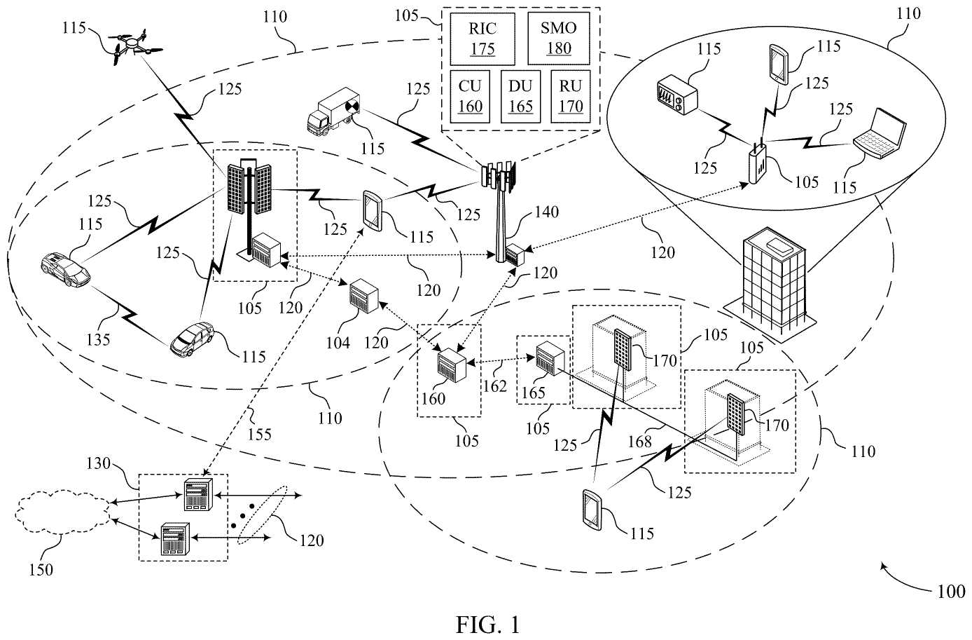

FIG. 1 shows an example of a wireless communications system 100 that supports interlaced search space configuration for reference signal sharing within a wireless communications system in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support interlaced search space configuration for reference signal sharing within a wireless communications system as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., CCEs (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a network entity 105 may schedule PDCCHs for multiple UEs 115 at once through reference signal sharing. reference signal sharing may reduce signaling and latency, while improving channel diversity, among other benefits. A UE 115 may be associated with a CCE group that may be divided into different REGs, or a REG bundle. In some cases, the REGs for a CCE group may be grouped into sub-groups (e.g., sub-REG bundles), such as one REG sub-group per CCE within a CCE group. A PDCCH (e.g., control channel) may span a REG sub-group. The sub-groups of REGs for one UE 115 may be interlaced with sub-groups of REGs for other UEs 115, such as co-located UEs 115. The REGs may be mapped to continuous resource blocks, but may be interlaced such that one REG sub-group for a UE 115 may be in a CCE next to a REG sub-group in a CCE for another UE 115. These resource blocks may be mapped to different RSs, allowing multiple UEs 115 to share a reference signal, which may span multiple REG bundles. For example, a REG bundle may include six REGs. In one example, a UE 115 may group three of the REGs, creating two sub-groups of REGs, which may be interlaced with sub-groups from another UE 115. A reference signal may span two interlaced REG sub-groups (e.g., a sub-group from the UE 115 and a sub-group from the other UE 115).

The interlacing of REG bundles and sub-REG bundles may be defined by an interlace index and, in some cases, a group index, which may be applied to the different CCEs associated with the sub-REG bundles such that interlaced sub-groups refer to the same CCE groups (via the group index) and have corresponding interlace indices within the CCE group. In some implementations, PDCCH candidates may be mapped to the interlaced CCEs. UEs 115 may monitor at the respective CCEs for PDCCHs that may schedule reference signals. In order to support DMRS sharing, the PDCCH candidates for co-located UEs 115, which may share reference signals to improve frequency diversity, may be mapped to the same interlaced CCE groups, or to consecutive interlaced CCEs. However, a network entity 105 may ensure that the co-located UEs 115 may be mapped to the same CCE group (e.g., may be interlaced with each other).

In some implementations, a network entity 105 may output an indication of a control channel configuration to a group of UEs 115, which may indicate a mapping between CCE groups and PDCCH (e.g., control channel) candidates (which may span the REG sub-groups) to support reference signal sharing. For example, the network entity 105 may configure a group of UEs 115 to support an interlaced search space associated with CCEs and may also indicate offsets, particular to each UE 115, for mapping PDCCH candidates to the interlaced CCEs in order to support reference signal sharing, particularly between co-located UEs 115. A UE 115 may monitor target PDCCHs at target CCEs within the interlaced search space based on the offsets and may receive reference signals via the interlaced search space and the target PDCCH. In some cases, the indication of the control channel configuration may indicate that the CCEs may be consecutively grouped into the CCE groups. The PDCCH candidates may be consecutively indexed to support interlacing based on the offsets, and may then be grouped together into CCE groups in accordance with the interlacing indices. That is, the PDCCH candidates associated with one UE 115 may not have consecutive indices because they may be interlaced with other PDCCH candidates within the CCE group. Alternatively, the indication of the control channel configuration may indicate that the PDCCH candidates may be grouped together based on the offsets, and then may be interlaced accordingly. That is, the PDCCH candidates associated with one UE 115 may have consecutive indices, and may be interlaced according to the offsets. In some cases, the indication of the control channel configuration may indicate that the PDCCH candidates may be mapped to the CCE groups using a two-step process. A PDCCH candidate to CCE mapping may be used to define an “anchor” CCE that may be the first CCE in the group, and the other CCEs may be mapped to the group based on the anchor CCE. After interlacing, the network entity 105 may transmit a reference signal to one CCE group via the PDCCHs (e.g., DMRS sharing).

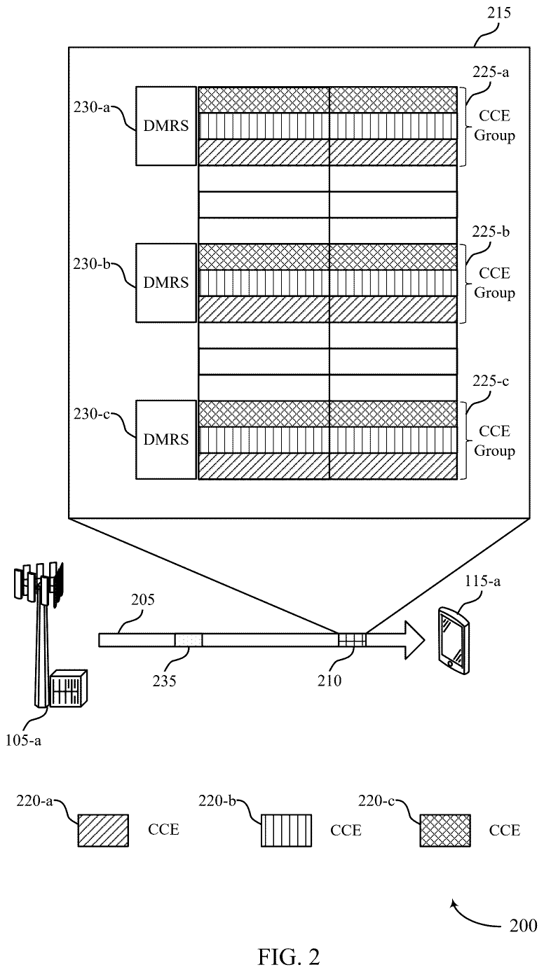

FIG. 2 shows an example of a wireless communications system 200 that supports interlaced search space configuration for reference signal sharing within a wireless communications system in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-a and the UE 115-a, which may be examples of corresponding devices as described herein, including with reference to FIG. 1. The techniques described herein in the context of the wireless communications system 200 may support methods of interlacing CCEs for co-located UEs 115 to support DMRS sharing.

In some wireless communications systems 200, the network entity 105-a may transmit, to the UE 115-a via a downlink communication link 205, control signaling 210 that indicates a control channel configuration 215. The control channel configuration 215 may indicate a mapping of CCEs 220 associated with one or more receiving UEs 115, including the UE 115-a and one or more other UEs 115 that communicate with the network entity 105-a and may be co-located with the UE 115-a (not pictured in FIG. 2). The control channel configuration 215 may indicate a framework or configuration for a control channel, in which one or more CCEs 220 (e.g., time and frequency resources allocated for a portion of the control channel) may be grouped into CCE groups 225. In some cases, CCEs 220 may be associated with (e.g., mapped to, configured to convey) a DMRS 230. Each CCE 220 may also be associated with (e.g., mapped to, configured to convey) one or more PDCCH candidates. The PDDCH candidates may convey control signaling output by the network entity 105-a. At least one PDCCH candidate of the one or more PDCCH candidates associated with each CCE 220 may schedule the DMRS 230.

In some implementations, a CCE 220 may include a quantity of REGs (e.g., six REGs). Each REG may include a resource block in a symbol (e.g., a time and frequency resource unit or element within the control channel). In some cases (e.g., non-interleaved, non-interlaced mapping), REGs associated with a CCE 220 may be mapped to continuous resource blocks. For example, a first CCE group 225, in a non-interleaved and non-interlaced mapping (not pictured in FIG. 2), may contain a full CCE 220 associated with the UE 115-a. In some examples, a precoder may be applied to a transmission to improve reliability and quality, among other benefits. In a non-interleaved mapping, the precoder may be the same across a CCE 220.

In some implementations, CCEs 220 associated with different UEs 115 may be interleaved, as shown in FIG. 2. In some cases, a CCE 220 may be split into REG bundles of different interleaver depths (e.g., 2, 3, 6). For example, the CCE 220-a may be associated with the UE 115-a, while the CCE 220-b and the CCE 220-c may be associated with some other UEs 115. The CCE 220-a, which may include six REGs, may be split into three sub-REG bundles (e.g., sub-groups of REGs), each including two REGs of the CCE 220-a, which may correspond to an interleaver depth of two (e.g., two REGs per sub-REG bundle). Each sub-REG bundle may then be interleaved with sub-REG bundles of the CCE 220-b and the CCE 220-c, forming CCE groups 225. The network entity 105-a may configure the sub-REG bundle size depending on a quantity of symbols available. In some examples, a precoder may be the same across a sub-REG bundle. The UE 115-a may receive one or more reference signals 235, which may include a DMRS 230, associated with each sub-REG bundle, and thus may perform channel estimation for each sub-REG bundle. This may improve reliability of communications with the UE 115-a, among other benefits.

In some implementations, a reference signal may be shared across multiple CCEs or CCE groups. For example, some wireless communications systems 200 (e.g., LTE) may support cell-specific reference signals (CRS), which may provide for a network entity 105 to communicate a CRS to all users within a serving cell. Some wireless communications systems 200 (e.g., NR) may not support CRS. However, in some implementations, the network entity 105-a may schedule PDCCHs with relatively low aggregation levels, such that fewer CCEs are used for transmission of a PDCCH. This may provide for the network entity 105-a to transmit DMRSs 230 across multiple PDCCHs, improving the channel estimation quality of PDCCH decoding. For example, a DMRS 230-a may be shared across CCEs 220 within a CCE group 225-a, which may contain sub-REG bundles of the CCE 220-a associated with the UE 115-a, and the CCEs 220-b and 220-c, associated with second and third UEs 115 (not pictured in FIG. 2). The DMRSs 230-b and 230-c may similarly be shared across CCEs 220 within the CCE group 225-b and the CCE group 225-c, respectively. The network entity 105-a may define common resource block (RB) or physical RB (PRB) groups across a control resource set (CORESET), such that a shared DMRS 230 associated with multiple PDCCHs may be transmitted for each DMRS bundle (e.g., sub-REG bundles sharing a DMRS 230). In some examples, the precoder may be the same across a DMRS bundle (e.g., in the control channel configuration 215, the CCE group 225-a may implement the same precoder).

In some implementations, the control channel configuration 215 may interlace the interleaved CCEs 220. That is, for interleaved CCEs 220, a CCE group 225 may be interlaced with other CCEs 220 or CCE groups 225 to diversify frequency coverage for channel estimation, which may improve communication quality, among other benefits. For example, the CCE groups 225-a, 225-b, and 225-c may be interlaced with the blank REGs shown in the control channel configuration 215. In some cases, to support interlacing of the CCE groups 225, the network entity 105-a may identify a quantity of CCEs 220 (e.g., K) to interleave and interlace. The control channel configuration 215 may map K interleaved CCEs 220 over the K CCEs 220 prior to interlacing to form the CCE groups 225 (e.g., a CCE group 225, prior to interleaving and interlacing, may be a CCE 220). That is, the K interleaved CCEs 220 may be mapped into CCE groups 225, such that the same quantity of CCEs 220 may be mapped across the CORESET with interlacing and interleaving introduced. For example, the CCE group 225-a may include interleaved CCEs 220, such that a sub-REG bundle for the CCE 220-a, a sub-REG bundle for the CCE 220-b, and a sub-REG bundle for the CCE 220-c may be included in the CCE group 225-a. CCE groups 225 may be interlaced with the blank REGs of the CORESET, which may include other CCEs 220, CCE groups 225, communications, or the like.

The network entity 105-a may interleave and interlace the CCEs 220 according to some grouping. In some implementations, to define the CCE groups 225 within a CORESET, the network entity 105-a may group contiguous quantities of CCEs 220 as a super CCE group (e.g., K-legacy CCE group, K-CCE group). For example, to generate three CCE groups 225 within a CORESET, the network entity 105-a may group three contiguous CCEs 220 as a super CCE group (e.g., three-CCE group, three-legacy CCE group). Within the super CCE group, the network entity 105-a may label the REGs within the CCE group 225 in a consecutive (e.g., natural) order. For example, the CCE group 225-a, the CCE group 225-b, and the CCE group 225-c may form a super CCE group (e.g., three-CCE group). The sub-REG bundles within the super CCE group may be labeled in a consecutive order. For example, the sub-REG bundles associated with the CCE 220-a may be labeled as zero. The sub-REG bundles associated with the CCE 220-b may be labeled as one, and the sub-REG bundles associated with the CCE 220-c may be labeled as two. In some cases, each REG may also be labeled consecutively across the CORESET. For example, the REGs in the CCE group 225-c may be labeled from zero to six, the blank REGs between the CCE group 225-c and the CCE group 225-b may be labeled from six to eleven, the REGs in the CCE group 225-b may be labeled from twelve to seventeen, and so one.

In other implementations, to define the CCE groups 225 within the CORESET, the network entity 105-a may use a PDCCH candidate to CCE mapping that may distribute PDCCH candidates uniformly across a CORESET. For example, a CCE 220 (e.g., the first CCE) associated with a PDCCH candidate (e.g., k) of a PDCCH candidate to CCE mapping may be used as an anchor CCE 220 (e.g., leading CCE 220) for the super CCE group from which to define the interlacing of the remaining CCEs 220. For example, the network entity 105-a may group three CCEs 220 to form a super CCE group (e.g., three-CCE group). The network entity 105-a may use the CCE 220-a as an anchor CCE 220 based on the CCE 220-a being the first CCE 220 associated with a PDCCH candidate (e.g., k) in the PDCCH candidate to CCE mapping. The network entity 105-a may then determine to use the CCE 220-b and the CCE 220-c as the remaining two CCEs based on using the CCE 220-a as an anchor CCE 220 and in accordance with the PDCCH candidate to CCE mapping. For example, the CCE 220-b may be the next CCE associated with the PDCCH candidate (e.g., k) in the PDCCH candidate to CCE mapping. Additionally, or alternatively, the CCE 220-b may be some preconfigured offset after the CCE 220-a in the PDCCH candidate to CCE mapping.

In some implementations, the CCEs 220 may be labeled with interlacing indices that may be unique to each CCE 220 across the CORESET. In some cases, the interlacing indices may be across the CORESET (e.g., universal). For example, the CCE 220-a may be associated with an interlace index of zero, the CCE 220-b may be labeled with an interlace index of one, and the CCE 220-c may have an interlace index of two. In some examples, the interlaced CCEs 220 may be indexed, or labeled, in accordance with the interlacing (e.g., after interlacing), and the CCEs 220 may be labeled, or indexed, and then may be interleaved within the CCE group 225 based on the interlace index. In other cases, the interlacing indices may be part of a two stage interlace indexing. That is, a first index may indicate a super CCE group (e.g., a group index) that the CCE 220 may be mapped into and a second index may indicate an interlace index within the group (e.g., an individual index) for a CCE 220. For example, the CCEs 220-a, 220-b, and 220-c may all be associated with a group index zero that may indicate the super CCE group containing the CCE groups 225-a, 225-b, and 225-c. The CCE 220-a may be associated with an interlace index of zero, while the CCE 220-b may be associated with an interlace of one and the CCE 220-c may be labeled with an interlace index of two.

Thus, the network entity 105-a may support one or multiple processes for determining interlace indices for interlacing CCEs 220. The network entity 105-a may also support one or more multiple methods for mapping a PDCCH search space candidate to the interlaced CCEs 220, which may be based on the interlace indices associated with the CCEs 220. In some examples, when using consecutive interlace indices, the PDCCH candidates may be mapped to unique interlace CCE indices that may be associated with one CCE 220. In other examples, when using a two stage interlace indexing, the PDCCH candidates may be mapped to specific group indices, or leading CCEs 220, and relative interlace indices indicating specific CCEs 220 within a super CCE group. Further, to support DMRS sharing across multiple PDCCHs, the multiple PDCCHS may be transmitted within a super CCE group. For example, a super CCE group may contain or otherwise be associated with (e.g., mapped to, scheduled to include communications for) multiple UEs 115 that may be co-located, and thus may support DMRS sharing. The network entity 105-a may configure the multiple PDCCHs to be transmitted within the same super CCE group, but at different interlace indices and thus at different CCEs 220, based on the interlace indexing process.

In some implementations, CCE indices (e.g., i) for a PDCCH candidate (e.g., k) at some time (e.g., t) may be determined by Equation 1, which may be an example of a hash function.

$${l}_{k , i} = L [ ( {Y}_{p , t} + \vert \frac{kC}{LM} \vert ) mod \vert \frac{C}{L} \vert ] + i \qquad ( 1 )$$

In the example of Equation 1, C may be the total quantity of CCEs 220 in a CORESET, L may be the aggregation level, and M may be the quantity of PDCCH candidates for an aggregation level (e.g., L). Y_{p,t} may be determined by a type of search space, and may define an offset in order to avoid collisions between PDCCHs. For example, for a common search space (CSS), Y_{p,t} may be zero. For a UE-specific search space (USS), Y_{p,t} may be (AₚY_{p,t-1}) mod (65537) and Y_{p,-1} may be C_{RNTI}, where C_{RNTI} may be a quantity of CCEs 220 that is specific to the corresponding UE 115. The offset for a CSS may be zero as there may not be collisions within a CSS. However, for a USS, the offset may ensure that CCEs 220 are assigned to UEs 115 to avoid collisions between the PDCCHs that may be sent via CCEs 220 for specific UEs 115. Equation 1 may map a quantity of CCEs 220 for an aggregation level such that the quantity of PDCCH candidates for the aggregation level may be mapped to contiguous CCEs 220. Different PDCCH candidates may be spaced out uniformly across available CCEs 220 for a CORESET. That is, Equation 1 may map PDCCH candidates to CCEs 220 across a CORESET for a non-interlaced CORESET (e.g., contiguous CCEs).

In order to support interlacing, the network entity 105-a may reinterpret or redefine aspects of Equation 1 to support a redefined CCE index (i) and to include an interlace index associated with CCEs 220. Introducing an offset for the CCEs 220, defined by the CCE index and interlace index, may indicate which CCE groups 225 map to which PDCCH candidates. This may ensure that the PDCCH candidates are evenly distributed across the interlaced CCEs 220. In some cases, the offset may be configured or signaled, such as by control signaling (e.g., RRC signaling). Additionally, or alternatively, a quantity of CCEs 220 associated with a quantity of PDCCH candidates indicated by an aggregation level may be placed in contiguous interlaced CCEs 220. For example, for an aggregation level of two, PDCCH candidates for a PDCCH may be placed in two contiguous CCEs 220 (e.g., 2-CCEs) that may have been contiguous CCEs 220 before interlacing.

In the example of the wireless communications system 200 described herein, the network entity 105-a may transmit, to the UE 115-a via the control signaling 210, an indication of the control channel configuration 215. The control channel configuration 215 may indicate a sub-REG bundle interlaced search space associated with an interlaced set of CCEs 220 and one or more offsets for mapping PDCCH candidates to the interlaced set of CCEs 220 to support DMRS sharing. For example, the network entity 105-a may configure a group of UEs 115, which may include the UE 115-a, to support an interlaced search space associated with CCEs 220 and may also indicate offsets for mapping PDCCH candidates to the interlaced CCEs 220 in order to support DMRS sharing, particularly between co-located UEs 115. The UE 115-a may monitor target PDCCHs at target CCEs 220 within the interlaced search space based on the offsets indicated in the control signaling 210 and may receive one or more DMRSs 230 via the interlaced search space and the target PDCCHs.

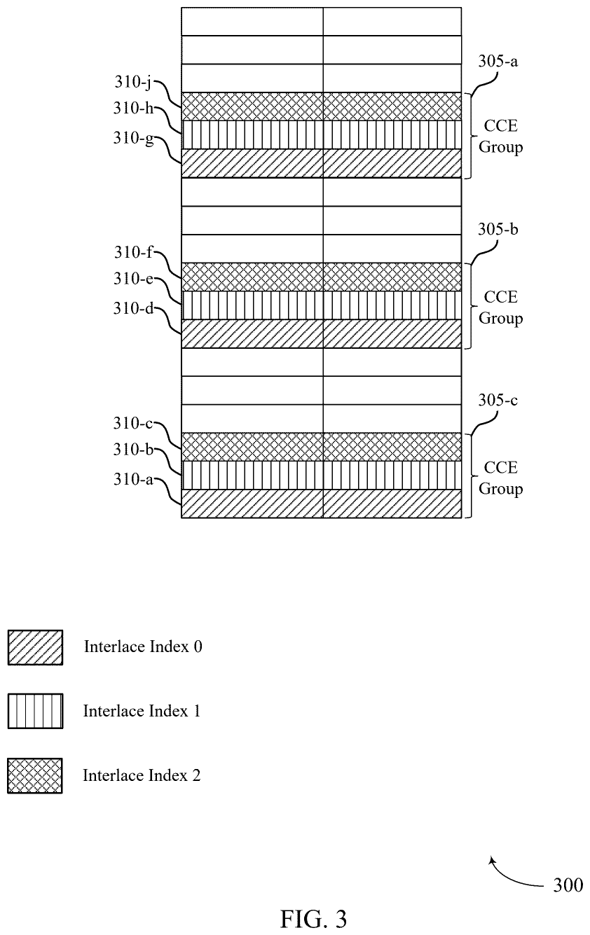

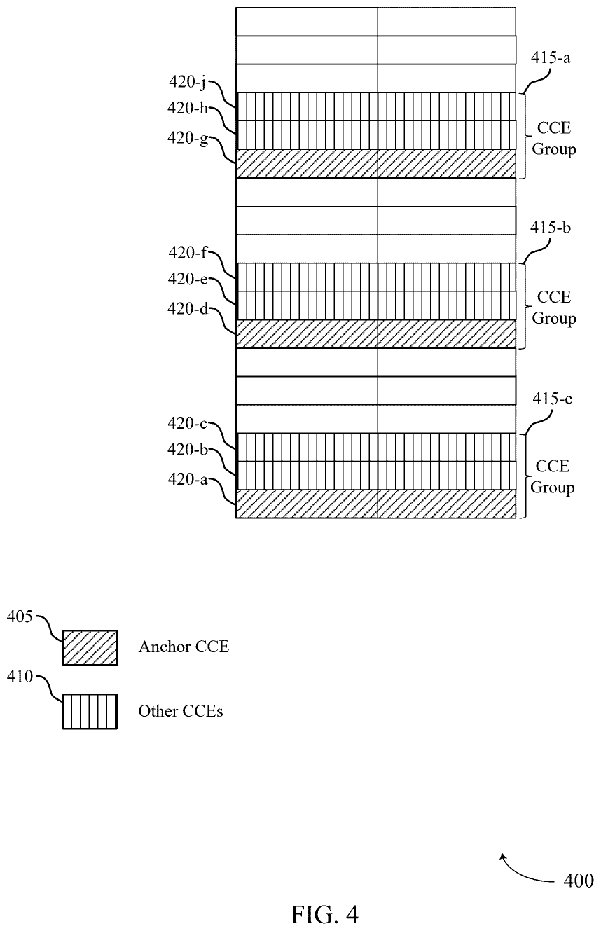

In some examples, the CCEs 220 may be consecutively grouped into CCE groups 225, as described in further detail elsewhere herein, including with reference to FIG. 3. The PDCCH candidates may be consecutively indexed to support interlacing based on the offsets, and may then be grouped together into CCE groups 225 in accordance with the interlacing indices associated with the CCEs 220. That is, the PDCCH candidates associated with the UE 115-a may not have consecutive indices because they may be interlaced with other PDCCH candidates within the CCE group 225. Additionally, or alternatively, the PDCCH candidates may be grouped together based on the offsets, and then may be mapped to the interlaced CCEs 220 accordingly. That is, the PDCCH candidates associated with the UE 115-a may have consecutive indices, and may be mapped to the interlaced CCEs 220 according to the offsets. In some cases, the PDCCH candidates may be mapped to the CCE groups 225 using a two-step process, as described in further detail elsewhere herein, including with reference to FIG. 4. A PDCCH candidate to CCE mapping for non-interlaced search spaces may be used to define an anchor CCE 220 that may be the first CCE 220 in the group, and the other CCEs 220 may be mapped to the group based on the anchor CCE 220. After interlacing, the network entity 105-b may transmit a DMRS 230, via the one or more reference signals 235, to one CCE group 225 via a target CCE 220, which may be scheduled in accordance with a PDCCH received at a PDCCH candidate mapped to the CCEs 220.

FIG. 3 shows an example of a mapping diagram 300 that supports interlaced search space configuration for reference signal sharing within a wireless communications system in accordance with one or more aspects of the present disclosure. The mapping diagram 300 may implement, or be implemented by, aspects of the wireless communications systems 100 or 200. For example, the mapping diagram 300 illustrates an example of a channel configuration for interlaced CCEs that support DMRS sharing across PDCCHs. The channel configuration may represent an example of the channel configuration 215 described with reference to FIG. 2 (e.g., including different mapping schemes) and may be used for communications between a network entity and one or more UEs, which may represent examples of corresponding devices as described with reference to FIGS. 1 and 2. The techniques described herein in the context of the mapping diagram 300 may support methods of interlacing CCEs to support DMRS sharing across PDCCHs in accordance with a universal interlace indexing procedure.

In some examples described herein, a group of UEs that are co-located (e.g., within a relatively close proximity of one another, operating on a same operating band, or the like) may share a DMRS for performing channel estimation and quality measurements, among other procedures. To support DMRS sharing across PDCCHs, multiple PDCCHs may be interlaced to the same CCE groups 305 (e.g., a super CCE group). Common DMRSs may occupy the CCE groups 305, or the super CCE group. In some cases, a network entity may schedule multiple UEs at a same time (e.g., for a high blocking probability) using a PDCCH to CCE hashing function, as described with reference to FIG. 2. Scheduled UEs may be co-located. In some cases, however, the network entity may not ensure which UEs are co-located and that co-located UEs are mapped to the same CCEs, for example.

In some implementations described herein, the network entity may utilize specific mappings or control channel configurations to ensure that a group of co-located UEs may share the same CCE groups 305, or the same super CCE group, while each having a different interlace index within the CCE groups 305. For example, the sub-REG bundles 310-a, 310-d, and 310-g, corresponding to interlace index zero, may form a CCE for a first UE, which may be co-located with a second UE associated with a CCE formed by the sub-REG bundles 310-b, 310-c, and 310-h associated with the interlace index one, and a third UE associated with a CCE formed by the sub-REG bundles 310-c, 310-f, and 310-j associated with the interlace index two. In some implementations, the interlaced CCEs may be assigned an interlace index according to the interlacing, which then may carry across a super CCE group. That is, the interlace index assigned to sub-REG bundles 310 within the CCE groups 305 may be the same if the sub-REG bundles correspond to the same CCE. Thus, every group (e.g., K) of interlaced CCEs may be mapped to the same super CCE group. For example, every CCE within a group of three interlaced CCEs may be mapped to the same three CCE groups 305.

In some implementations, rather than mapping PDCCH candidates to CCEs, the network entity may map PDCCH candidates to specific super CCE groups, where groups of UEs may use different interlace indices within the CCE groups 305 of the super CCE group. A network entity may transmit associated PDCCHs within the super CCE groups, which may allow for a wireless communications system to support DMRS sharing. That is, for a super CCE group (e.g., three-CCE group) of CCE groups 305-a, 305-b, and 305-c (e.g., three CCE groups 305), a network entity may transmit three PDCCHs across the CCE groups 305. For example, the network entity may output a first PDCCH to a first UE across sub-REG bundles 310-a, 310-d, and 310-g, which may schedule three DMRSs. The network entity may output a second PDCCH to a second UE across sub-REG bundles 310-b, 310-e, and 310-h, which may schedule the same three DMRSs. The network entity may output a third PDCCH to a third UE across sub-REG bundles 310-c, 310-f, and 310-j, which may schedule the same three DMRSs. The network entity may transmit the three scheduled DMRSs across the CCE groups 305, such that the UEs may share the DMRSs.

In some implementations (e.g., universal interlaced indexing), a PDCCH candidate may be mapped (e.g., hashed) to super CCE groups. For example, CCE groups 305-a, 305-b and 305-c may form a super CCE group (e.g., three-legacy CCE group, three-CCE group). Within a CORESET, there may be a quantity of CCEs, C, within the CORESET and a quantity of CCEs, K, within a super CCE group. There may be a quantity of super CCE groups, C′, in the CORESET, where

$${C}^{′} = \frac{C}{K} .$$

A PDCCH candidate, k, may be mapped, based on an aggregation level, L, into L super CCE groups using a group index, as shown in Equation 2.

$${G}_{{k}^{′} , {i}^{′}} = L [ ( {Y}_{p , t} + \vert \frac{{k}^{′} {C}^{′}}{{LM}^{′}} \vert ) mod \vert \frac{{C}^{′}}{L} \vert ] + {i}^{′} \qquad ( 2 )$$

In the example of Equation 2,

$${k}^{′} = \vert \frac{k}{K} \vert or k , {M}^{′} = \frac{M}{K}$$

or M, depending on an interlacing procedure, and i′ may span from zero to L−1. This may allow PDCCH candidates with different k′ values to be uniformly distributed across a CORESET. Y_{p,t} may determine a group offset. An aggregation level of L may indicate that PDCCH candidates may be mapped to Z contiguous super CCE groups. Within one super CCE group, there may be one or multiple PDCCH candidates. For example, there may be up to K PDCCH candidates for a PDCCH in a super CCE group.

In some implementations, within a super CCE group, there may be K PDCCH candidates associated with a PDCCH. In this case,

$${k}^{′} = \vert \frac{k}{K} \vert and {M}^{′} = \frac{M}{K} .$$

Each PDCCH candidate may be mapped to a different interlace index within the super CCE group. The k-th PDCCH candidate may have a k mod K-th interlace in the associated super CCE group. For example, for a super CCE group containing three CCE groups 305, a 0-th PDCCH candidate may have a 0 mod (3)-th interlace index, or an interlace index of zero. A 3-rd PDCCH candidate may take a 3 mod (3)-th interlace index, or an interlace index of zero. Equation 2 may indicate which CCE groups 305 the PDCCH candidates may be mapped (e.g., the group index). The group index may be related to the associated interlace index using a hashing function. In some examples, the interlace index for each PDCCH candidate may be determined, and the appropriate CCE groups 305 may be defined for the associated super CCE group. The CCE group index, as defined by Equation 2, may be related to the CCE interlace index, as defined in Equation 1, as l_{k,i=i′=}=K*G_{k′,i′}+k mod K. In some other examples, the PDCCH candidates may be distributed across the CCE groups 305 for the associated super CCE group, and the interlace indices may be defined. The CCE group index, as defined by Equation 2, may be related to the CCE interlace index, as defined in Equation 1, as

$${l}_{k , i = {i}^{′} =} = {G}_{{k}^{′} , {i}^{′}} + \vert \frac{k}{K} \vert * {M}^{′} .$$

Both examples may result in consecutive mapping of PDCCH candidates to interlaces. For example, sub-REG bundle 310-a may be associated with interlace index zero and PDCCH candidate zero. Sub-REG bundle 310-b may be associated with interlace index one and PDCCH candidate one, while sub-REG bundle 310-c may be associated with interlace index two and PDCCH candidate two. Sub-REG bundle 310-d may be associated with interlace index zero and PDCCH candidate four, and so on. A UE may monitor each PDCCH candidate associated with an interlace index mapped to a CCE associated with the UE.

In some implementations, within one super CCE group, there may be a quantity, K, of PDCCH candidates from a PDCCH that may be mapped to different CCE groups 305, where the interlace index of a CCE within a CCE group 305 may be preconfigured (e.g., y). Different PDCCHs may be configured with different interlace indices to allow DMRS sharing across CCE groups 305. That is, the PDCCH candidates may be distributed consecutively across one interlace index. In this case, k′=k and M′=M. The group index may be related to the associated interlace index using a hashing function. In some examples, the interlace index for each PDCCH candidate may be determined, and then the appropriate CCE groups 305 may be defined for the associated super CCE group. The CCE group index, as defined by Equation 2, may be related to the CCE interlace index, as defined in Equation 1, as l_{ki=i′=}=K*G_{k′,i′}+y. In other examples, the PDCCH candidates may be distributed across the CCE groups 305 for the associated super CCE group, and then the interlace indices may be defined. The CCE group index, as defined by Equation 2, may be related to the CCE interlace index, as defined in Equation 1, as l_{k,i=i′=}=G_{k′,i′}+y*M′. Both examples may result in consecutive mapping of PDCCH candidates within an interlace index. For example, sub-REG bundle 310-a may be associated with interlace index zero and PDCCH candidate zero, while sub-REG bundle 310-d may be associated with interlace index zero and PDCCH candidate 1, and so on. A UE may monitor each PDCCH candidate associated with an interlace index mapped to a CCE associated with the UE.

To multiplex the quantity, K, of PDCCHs in a CCE group 305, but with different interlace indices, the search space associated with the PDCCHs may be aligned. That is, the group offset, Y_{p,t}, of Equations 1 and 2 may be the same across a group of PDCCHs, which may ensure the PDCCH candidates associated with the PDCCHs may be mapped to the same CCE groups 305, while the PDCCHs may occupy different interlaces. The group offset Y_{p,t} may determine the group offset for PDCCH candidate to CCE group index mapping. If Y_{p,t} is the same for a group of PDCCHs, the PDCCH candidates associated with the PDCCHs may be mapped to the same CCE groups 305. That is, Y_{p,t} may be the same for a group of PDCCH that share a common DMRS. As described in further detail elsewhere herein, including with reference to FIG. 2, for a USS, Y_{p,t}=(AₚY_{p,t-1}) mod (65537) where Y_{p,-1}=C_{RNTI}, which may be UE-specific. However, the network entity may configure Y_{p,-1} to be the same for CCE groups 305 that will share a common DMRS, such that Y_{p,t} will be the same for a group of PDCCH sharing common DMRS across a group of UEs, such as co-located UEs.

In some examples, interlaced CCEs may be indexed in a consecutive order (e.g., universal interlace indexing, as described further with reference to FIG. 2). For consecutively indexed interlaced CCEs, each PDCCH may have PDCCH candidates in all the interlaces within a set of CCE groups 305. The network entity may transmit the PDCCHs within the same CCE groups, but with different interlaces, which may support DMRS sharing across the CCE group 305. In some examples, interlaced CCEs may be associated with a group index and an interlace index within a group (e.g., two-stage interlace indexing). The PDCCHS may be configured with different interlaces within a CCE group 305. The network entity may transmit PDCCHs configured with different interlaces within the same CCE group 305, which may support DMRS sharing across the CCE group 305.

FIG. 4 shows an example of a mapping diagram 400 that supports interlaced search space configuration for reference signal sharing within a wireless communications system in accordance with one or more aspects of the present disclosure. The mapping diagram 400 may implement, or be implemented by, aspects of the wireless communications systems 100 or 200. For example, the mapping diagram 400 illustrates an example of a channel configuration for interlaced CCEs that support DMRS sharing across PDCCHs. The channel configuration may represent an example of the channel configuration 215 described with reference to FIG. 2 (e.g., including different mapping schemes) and may be used for communications between a network entity and one or more UEs, which may represent examples of corresponding devices as described with reference to FIGS. 1-3. The techniques described herein in the context of the mapping diagram 400 may support methods of mapping PDCCH candidates to interlaced CCEs to support DMRS sharing in a two-stage procedure.

In some examples, a network entity and corresponding UEs may support interlace indexing based on a leading, or anchor CCE 405, as described with reference to FIG. 2. For example, to define the CCE groups within the CORESET, the network entity may re-use a PDCCH candidate to CCE mapping for non-interlaced search spaces. A CCE (e.g., the first CCE) associated with a PDCCH candidate (e.g., k) of the PDCCH candidate to CCE mapping may be used as an anchor CCE 405 for the super CCE group. The anchor CCE 405 may be used to determine the other CCEs 410 forming the interlaced search space. In order to support uniform mapping of the PDCCH candidates to the interlaced CCEs, the anchor CCEs 405 may be associated with indices, where the indices may be mapped uniformly across the CCEs within the CORESET.

In some implementations, the anchor CCE 405 may be mapped to sub-REG bundles 420 (e.g., sub-REG bundles 420-a, 420-d, and 420-g) sequentially across different CCE groups 415 (e.g., the CCE groups 415-a, 415-b, and 415-c), and may be interlaced with the other CCEs 410 of other sub-REG bundles 420-b, 420-c, 420-c, 420-f, 420-h, and 420-j. For example, the network entity may partition the PDCCH candidates into groups of contiguous PDCCH candidates. That is, M PDCCH candidates may be partitioned into K groups of PDCCH candidates, where each group of contiguous PDCCH candidates may include

$$⌈ \frac{M}{K} ⌉ PDCCH$$

candidates. Within the group of contiguous PDCCH candidates, the anchor CCE 405 associated with first PDCCH candidate k in the group of contiguous PDCCH candidates may be mapped to PDCCH candidates using Equation 3, a hashing function related to Equation 1, where i=0 for the first PDCCH candidate k.

$${l}_{k , 0} = L [ ( {Y}_{p , t} + \vert \frac{kC}{L ⌈ \frac{M}{K} ⌉} \vert ) mod ⌊ \frac{C}{L} ⌋ ] \qquad ( 3 )$$

In the example of Equation 3, M may be a quantity of PDCCH candidates for an aggregation level, L. A network entity may use the function shown by Equation 3 to hash PDCCH candidates to anchor CCEs in a non-consecutive order. That is, the PDCCH candidates may be mapped sequentially across CCE groups 415 before the CCE groups 415 may be interlaced, resulting in non-consecutive PDCCH candidate mapping to interlace index mapping. For example, PDCCH candidates zero and three may be associated with a first anchor CCE 405, while PDCCH candidates one and four may be associated with a second anchor CCE 405, and PDCCH candidates two and five may be associated with a third anchor CCE 405.

The other CCEs 410 within a super CCE group of the CCE groups 415 may be associated with other PDCCH candidate groups for different UEs. Within the PDCCH candidate groups, the other CCEs 410 may be associated with the same PDCCH candidate indices as the anchor CCEs. For example, PDCCH candidates zero and three of a PDCCH candidate group associated with a different UE may be associated with another CCE 410 interlaced with the first anchor CCE 405. To determine which interlace index another CCE 410 may use within a CCE group, each other CCE 410 may be associated with a group index,

$$ℊ = ⌊ \frac{k}{⌈ \frac{M}{K} ⌉} ⌋ ,$$

which may indicate an offset from the anchor CCE 405. That is, a PDCCH candidate group with a group index g may take the g-th CCE interlace index in an associated super CCE group of CCE groups 415. For example, the anchor CCE 405 may be associated with g=0, and may be associated with a PDCCH candidate zero mapped to the sub-REG bundle 420-a, a PDCCH candidate three mapped to the sub-REG bundle 420-b, and a PDCCH candidate six mapped to the sub-REG bundle 420-c. Another CCE 410 may be associated with g=1, and may have the interlace index of one within the CCE groups 415. That is, the other CCE 410 with g=1 may be mapped to the sub-REG bundles 420-b, 420-e, and 420-h. The PDCCH candidates for the other CCE 410 with g=1 may be the PDCCH candidates zero, three, and six associated with a different PDCCH candidate group than the anchor CCE 405, as the PDCCH candidates may be associated with PDCCHs for different UEs.

In some implementations, the anchor CCE 405 may be mapped to a super CCE group and the super CCE group may support K PDCCH candidates for K CCEs in the super CCE group. In some cases, the M/K groups of PDCCH candidates may be spread across the anchor CCE 405 and other CCEs 410 while allowing K PDCCH candidates in the super CCE group. The anchor CCE 405 associated with the first PDCCH candidate k in the group of contiguous PDCCH candidates may be mapped to PDCCH candidates using Equation 4, a hashing function related to Equation 1, where i=0 for the first PDCCH candidate k.

$${l}_{k , 0} = L [ ( {Y}_{p , t} + \vert \frac{{k}^{′} C}{L ⌈ \frac{M}{K} ⌉} \vert ) mod ⌊ \frac{C}{L} ⌋ ] , {k}^{′} = ⌊ \frac{k}{K} ⌋ \qquad ( 4 )$$

The K PDCCH candidates for the super CCE group may be distributed consecutively across the super CCE group. For example, the k-th PDCCH candidate may be associated with the k mod K-th interlace in an associated super CCE group. Thus, K PDCCH candidates may be mapped to the K CCEs within a super CCE group beginning with the anchor CCE 405. In some implementations, to allow DMRS sharing across a CCE group 415, the group of PDCCHs may be hashed to the same anchor CCE 405.

In some cases, the network entity may configure a group of UEs that may share a DMRS (e.g., co-located UEs) to have aligned search spaces. That is, the group offset, Y_{p,t}, of Equations 1˜4 may be configured to be the same across a group of PDCCHs, which may ensure the PDCCH candidates associated with the PDCCHs may be mapped to the same CCE groups 415. The group offset Y_{p,t} may determine the group offset for PDCCH candidate to CCE group index mapping. If Y_{p,t} is the same for a group of PDCCHs, the PDCCH candidates associated with the PDCCHs may be mapped to the same CCE groups 415. Y_{p,t} may be the same for a group of PDCCHs that may share a common DMRS. As described in further detail elsewhere herein, including with reference to FIG. 2, for a USS, Y_{p,t}=(AₚY_{p,t-1})mod(65537) where Y_{p,-1}=C_{RNTI}, which may be UE specific. However, the network entity may configure Y_{p,-1} to be the same for CCE groups 415 that will share a common DMRS, such that Y_{p,t} will be the same for a group of PDCCHs sharing common DMRS across a group of UEs. The network entity may transmit multiple PDCCHs in a CCE group 415 beginning with the anchor CCE 405, but at different interlaces.

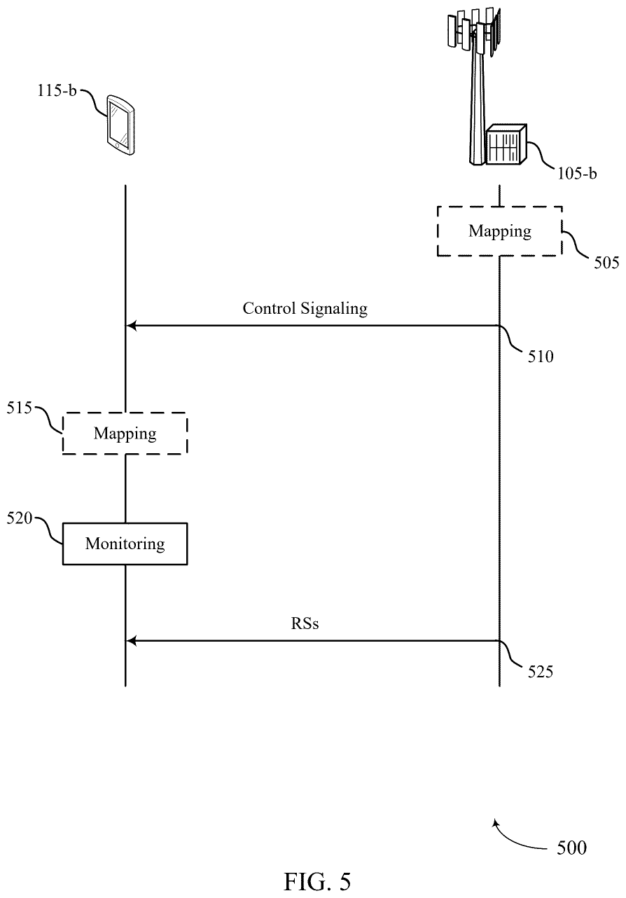

FIG. 5 shows an example of a process flow 500 that supports interlaced search space configuration for reference signal sharing within a wireless communications system in accordance with one or more aspects of the present disclosure. The process flow 500 may implement, or be implemented by, aspects of the wireless communications systems 100 or 200, or mapping diagrams 300 or 400. For example, the process flow 500 illustrates communications between a UE 115-b and a network entity 105-b, which may represent examples of corresponding devices as described herein, including with reference to FIGS. 1-4. The techniques described herein in the context of process flow 500 may support indexing interlaced CCEs to support DMRS sharing across a group of UEs 115.

In some implementations, at 505, the network entity 105-b may map one or more downlink control channel candidates (e.g., PDCCH candidates) to an interlaced set of CCEs. The network entity 105-b may map the one or more downlink control channel candidates to the interlaced set of CCEs in accordance with a CCE group index, a CCE index, or both.

Additionally, or alternatively, at 505, the network entity 105-b may map the one or more downlink control channel candidates to multiple sets of CCEs in accordance with an aggregation level configured for communications by the network entity 105-b, where the multiple sets of CCEs may include at least the interlaced set of CCEs. In some cases, a quantity of sets of CCEs in the multiple sets of CCEs may be in accordance with the aggregation level. In some cases, the one or more downlink control channel candidates may include a quantity of downlink control channel candidates, and the quantity of downlink control channel candidates may be in accordance with a quantity of sets of CCEs within the multiple sets of CCEs.

, or alternatively, each downlink control channel candidate of the one or more downlink control channel candidates may be associated with a respective consecutive index. In such implementations, at 505, the network entity 105-b may map the one or more downlink control channel candidates to the interlaced set of CCEs in accordance with the respective consecutive index and a quantity of groups of CCEs in the interlaced set of CCEs, where the network entity 105-b may output one or more reference signals via one or more target CCEs, as described at 525, in accordance with mapping the one or more downlink control channel candidates to the interlaced set of CCEs. In some implementations, at 505, the network entity 105-b may map the one or more downlink control channel candidates to the interlaced set of CCEs in accordance with the respective consecutive index and a respective interlace index, the respective interlace index indicated via the control channel configuration, as described at 510, where the network entity 105-b may output one or more reference signals at one or more target CCEs, as described at 525, in accordance with mapping the one or more downlink control channel candidates to the interlaced set of CCEs. In some cases, the network entity 105-b may output, via at least one downlink control channel candidate, the one or more reference signals to a group of UEs, as described at 525, in accordance with the control channel configuration mapping the at least one downlink control channel candidate to the interlaced set of CCEs.

Additionally, or alternatively, each downlink control channel candidate of the one or more downlink control channel candidates may be associated with a respective leading CCE associated with a respective leading CCE index, where each downlink control channel candidate of the one or more downlink control channel candidates may be associated with a respective CCE index in accordance with the leading CCE index. In such cases, at 505, the network entity 105-b may map the one or more downlink control channel candidates to the interlaced set of CCEs in accordance with the respective leading CCE index and a quantity of CCEs in the interlaced set of CCEs, where the network entity 105-b may output one or more reference signals at one or more target CCEs, as described at 525, in accordance with mapping the one or more downlink control channel candidates to the interlaced set of CCEs. In some cases, the network entity 105-b may map the one or more downlink control channel candidates to the interlaced set of CCEs in accordance with a quantity of CCEs in the interlaced set of CCEs and a quantity of groups of CCEs in the interlaced set of CCEs, where the network entity 105-b may output one or more reference signals at one or more target CCEs, as described at 525, in accordance with mapping the one or more downlink control channel candidates to the interlaced set of CCEs. In some cases, the network entity 105-b may output, via at least one downlink control channel candidate, one or more reference signals, as described further at 525, to the group of UEs in accordance with the mapping associated with the respective leading CCE.

Although the mapping at 505 is illustrated prior to other communication, the network entity 105-b may perform the mapping in any order. For example, the network entity 105-b may perform the mapping before transmitting one or more reference signals, as described at 525, or after transmitting control signaling, as described at 510. The mapping may indicate or otherwise include one or more offsets for mapping downlink control channel candidates, each associated with one or more respective UEs 115, to interlaced CCEs for reference signal sharing across multiple UEs 115 including at least the UE 115-b.

At 510, the UE 115-b may receive, and the network entity 105-b may output, control signaling that may indicate a control channel configuration for reference signal sharing across a group of UEs 115 including at least the UE 115-b, where the control channel configuration may indicate a sub-REG bundle interlaced search space associated with an interlaced set of CCEs and one or more offsets for mapping one or more downlink control channel candidates to the interlaced set of CCEs in accordance with the reference signal sharing across the group of UEs 115. In some cases, the UE 115-b may be co-located with one or more other UEs 115 of the group of UEs 115 and the one or more offsets may be in accordance with the collocation, as described with reference to FIGS. 2-4. In some cases, the control channel configuration may indicate that each downlink control channel candidate of the one or more downlink control channel candidates is associated with a respective consecutive index, as described with reference to Equation 2. Additionally, or alternatively, the control channel configuration may indicate that each downlink control channel candidate of the one or more downlink control channel candidates is associated with a respective leading CCE (e.g., anchor CCE) associated with a respective leading CCE index, where each downlink control channel candidate of the one or more downlink control channel candidates may be associated with a respective CCE index in accordance with the leading CCE index, as described with reference to Equation 3.

In some implementations, at 515, the UE 115-b may map the one or more downlink control channel candidates to the interlaced set of CCEs. In some cases, at 515, the UE 115-b may map the one or more downlink control channel candidates to the interlaced set of CCEs in accordance with a CCE group index, a CCE index, or both, and in accordance with the one or more offsets indicated via the control signaling, where the one or more target CCEs may be monitored by the UE 115-b, as described at 520, in accordance with mapping the one or more downlink control channel candidates to the interlaced set of CCE.

Additionally, or alternatively, at 515, the UE 115-b may map the one or more downlink control channel candidates to multiple sets of CCEs in accordance with the one or more offsets indicated via the control signaling, an aggregation level, or both, where the multiple sets of CCEs may include at least the interlaced set of CCEs and wherein the one or more target CCEs may be monitored by the UE 115-b, as described further at 520, in accordance with mapping the one or more downlink control channel candidates to the multiple sets of CCEs. In some cases, a quantity of sets of CCEs in the multiple sets of CCEs may be in accordance with the aggregation level. In some cases, the one or more downlink control channel candidates may include a quantity of downlink control channel candidates, and the quantity of downlink control channel candidates may be in accordance with a quantity of sets of CCEs within the multiple sets of CCEs.

Additionally, or alternatively, as discussed at 510, the control channel configuration may indicate that each downlink control channel candidate of the one or more downlink control channel candidates may be associated with a respective consecutive index. In such cases, at 515, the UE 115-b may map the one or more downlink control channel candidates to the interlaced set of CCEs in accordance with the respective consecutive index and a quantity of groups of CCEs in the interlaced set of CCEs (e.g., according to Equation 2, in some examples), where the one or more target CCEs may be monitored, as described further at 520, in accordance with mapping the one or more downlink control channel candidates to the interlaced set of CCEs. In some cases, at 515, the UE 115-b may map the one or more downlink control channel candidates to the interlaced set of CCEs in accordance with the respective consecutive index and a respective interlace index, the respective interlace index indicated in the control channel configuration, as described at 510, where the one or more target CCEs may be monitored, as described further at 520, in accordance with mapping the one or more downlink control channel candidates to the interlaced set of CCEs.

Additionally, or alternatively, as described at 510, the control channel configuration may indicate that each downlink control channel candidate of the one or more downlink control channel candidates is associated with a respective leading CCE associated with a respective leading CCE index, where each downlink control channel candidate of the one or more downlink control channel candidates may be associated with a respective CCE index in accordance with the leading CCE index. In such cases, at 515, the UE 115-b may map the one or more downlink control channel candidates to the interlaced set of CCEs in accordance with the respective leading CCE index (e.g., anchor CCE index) and a quantity of CCEs in the interlaced set of CCEs (e.g., according to Equation 3, in some examples), where the one or more target CCEs may be monitored, as described further at 520, in accordance with mapping the one or more downlink control channel candidates to the interlaced set of CCEs. In some cases, the UE 115-b may map the one or more downlink control channel candidates to the interlaced set of CCEs in accordance with a quantity of CCEs in the interlaced set of CCEs and a quantity of groups of CCEs in the interlaced set of CCEs, where the one or more target CCEs may be monitored, as described further at 520, in accordance with mapping the one or more downlink control channel candidates to the interlaced set of CCEs.

At 520, the UE 115-b may monitor one or more target CCEs of the interlaced set of CCEs in accordance with at least one offset of the one or more offsets, for at least one target downlink control channel of multiple downlink control channels associated with the one or more downlink control channel candidates. The at least one target downlink control channel may be associated with (e.g., mapped to, assigned to) the UE 115-b. In some cases, the UE 115-b may monitor the one or more target CCEs in accordance with the mapping, as described at 515. For example, the mapping may indicate which CCEs the UE 115-b should monitor. The offsets indicated by the network entity 105-b via the control signaling may thereby indicate, to the UE 115-b (e.g., and one or more other co-located UEs 115) which respective CCEs each of the UE 115-b and the one or more other UEs 115 should monitor. The configured CCE monitoring patterns across co-located UEs 115 may improve reference signal sharing, improve throughput, and improve communication reliability, among other examples.

At 525, the UE 115-b may receive, and the network entity 105-a may output, via the one or more target CCEs, one or more reference signals in accordance with monitoring for the at least one target downlink control channel, as described at 520. In some cases, a first subset of downlink control channel candidates of the one or more downlink control channel candidates may share a common DMRS sequence associated with a shared DMRS, and receiving the one or more reference signals may include receiving the shared DMRS via at least one downlink control channel candidate of the first subset of downlink control channel candidates. In some cases, the network entity 105-b may output the one or more reference signals at the one or more target CCEs in accordance with the mapping at the network entity 105-b, as described at 505. In some examples, the network entity 105-b may output, via at least one downlink control channel candidate, the one or more reference signals to a group of UEs 115 in accordance with the control channel configuration mapping the at least one downlink control channel candidate to the interlaced set of CCEs, as described at 505 and 510. In some examples, the network entity 105-b may output, via at least one downlink control channel candidate, one or more reference signals to the group of UEs 115 in accordance with the mapping associated with the respective leading CCE, as described at 505 and 510.

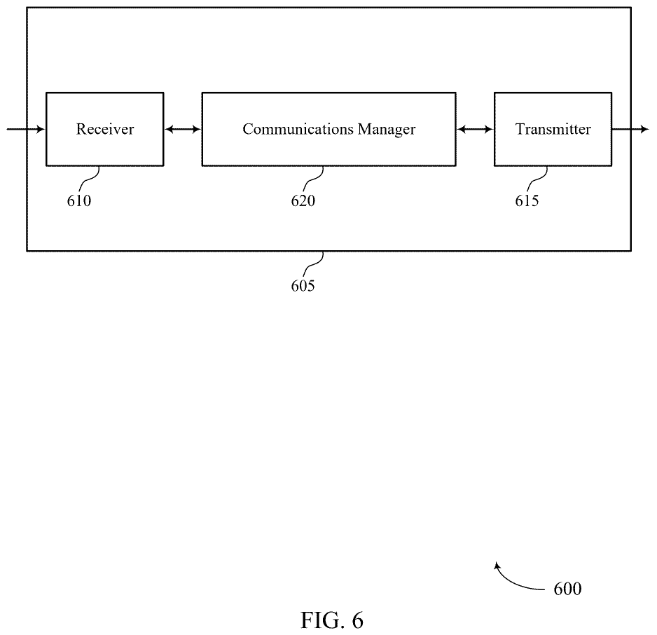

FIG. 6 shows a block diagram 600 of a device 605 that supports interlaced search space configuration for reference signal sharing within a wireless communications system in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to interlaced search space configuration for reference signal sharing within a wireless communications system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to interlaced search space configuration for reference signal sharing within a wireless communications system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of interlaced search space configuration for reference signal sharing within a wireless communications system as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The communications manager 620 is capable of, configured to, or operable to support a means for monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE. The communications manager 620 is capable of, configured to, or operable to support a means for receiving, at the one or more target CCEs, one or more reference signals in accordance with monitoring for the at least one target downlink control channel.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced latency, and more efficient utilization of communication resources.

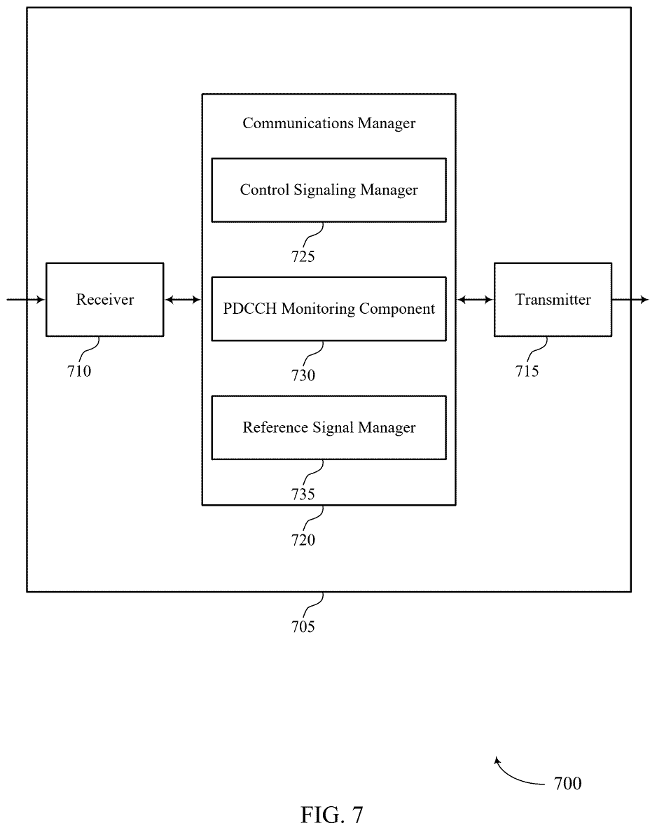

FIG. 7 shows a block diagram 700 of a device 705 that supports interlaced search space configuration for reference signal sharing within a wireless communications system in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to interlaced search space configuration for reference signal sharing within a wireless communications system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to interlaced search space configuration for reference signal sharing within a wireless communications system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of interlaced search space configuration for reference signal sharing within a wireless communications system as described herein. For example, the communications manager 720 may include a control signaling manager 725, a PDCCH monitoring component 730, a reference signal manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control signaling manager 725 is capable of, configured to, or operable to support a means for receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The PDCCH monitoring component 730 is capable of, configured to, or operable to support a means for monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE. The reference signal manager 735 is capable of, configured to, or operable to support a means for receiving, at the one or more target CCEs, one or more reference signals in accordance with monitoring for the at least one target downlink control channel.

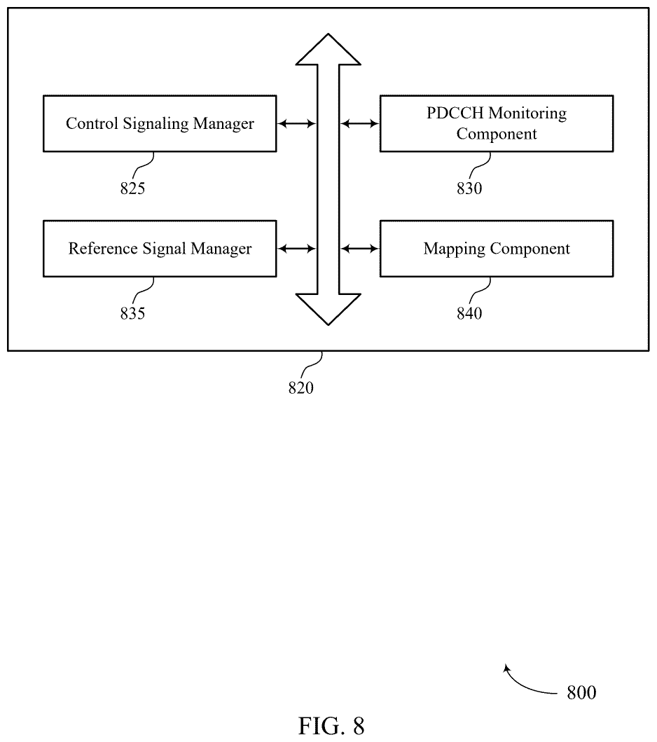

FIG. 8 shows a block diagram 800 of a communications manager 820 that supports interlaced search space configuration for reference signal sharing within a wireless communications system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of interlaced search space configuration for reference signal sharing within a wireless communications system as described herein. For example, the communications manager 820 may include a control signaling manager 825, a PDCCH monitoring component 830, a reference signal manager 835, a mapping component 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control signaling manager 825 is capable of, configured to, or operable to support a means for receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The PDCCH monitoring component 830 is capable of, configured to, or operable to support a means for monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE. The reference signal manager 835 is capable of, configured to, or operable to support a means for receiving, at the one or more target CCEs, one or more reference signals in accordance with monitoring for the at least one target downlink control channel.

In some examples, the mapping component 840 is capable of, configured to, or operable to support a means for mapping the one or more downlink control channel candidates to the interlaced set of CCEs in accordance with a CCE group index, a CCE index, or both, and in accordance with the one or more offsets, where the one or more target CCEs are monitored in accordance with mapping the one or more downlink control channel candidates to the interlaced set of CCEs.

In some examples, the mapping component 840 is capable of, configured to, or operable to support a means for mapping the one or more downlink control channel candidates to a set of multiple sets of CCEs in accordance with the one or more offsets, an aggregation level, or both, where the set of multiple sets of CCEs includes at least the interlaced set of CCEs and where the one or more target CCEs are monitored in accordance with mapping the one or more downlink control channel candidates to the set of multiple sets of CCEs.

In some examples, a quantity of sets of CCEs in the set of multiple sets of CCEs is in accordance with the aggregation level.

In some examples, the one or more downlink control channel candidates include a quantity of downlink control channel candidates, the quantity of downlink control channel candidates in accordance with a quantity of sets of CCEs within the set of multiple sets of CCEs.

In some examples, the control channel configuration indicates that each downlink control channel candidate of the one or more downlink control channel candidates is associated with a respective consecutive index.

In some examples, the mapping component 840 is capable of, configured to, or operable to support a means for mapping the one or more downlink control channel candidates to the interlaced set of CCEs in accordance with the respective consecutive index and a quantity of groups of CCEs in the interlaced set of CCEs, where the one or more target CCEs are monitored in accordance with mapping the one or more downlink control channel candidates to the interlaced set of CCEs.

In some examples, the mapping component 840 is capable of, configured to, or operable to support a means for mapping the one or more downlink control channel candidates to the interlaced set of CCEs in accordance with the respective consecutive index and a respective interlace index, the respective interlace index indicated in the control channel configuration, where the one or more target CCEs are monitored in accordance with mapping the one or more downlink control channel candidates to the interlaced set of CCEs.

In some examples, the control channel configuration indicates that each downlink control channel candidate of the one or more downlink control channel candidates is associated with a respective leading CCE associated with a respective leading CCE index. In some examples, each downlink control channel candidate of the one or more downlink control channel candidates is associated with a respective CCE index in accordance with the leading CCE index.

In some examples, the mapping component 840 is capable of, configured to, or operable to support a means for mapping the one or more downlink control channel candidates to the interlaced set of CCEs in accordance with the respective leading CCE index and a quantity of CCEs in the interlaced set of CCEs, where the one or more target CCEs are monitored in accordance with mapping the one or more downlink control channel candidates to the interlaced set of CCEs.

In some examples, the mapping component 840 is capable of, configured to, or operable to support a means for mapping the one or more downlink control channel candidates to the interlaced set of CCEs in accordance with a quantity of CCEs in the interlaced set of CCEs and a quantity of groups of CCEs in the interlaced set of CCEs, where the one or more target CCEs are monitored in accordance with mapping the one or more downlink control channel candidates to the interlaced set of CCEs.

In some examples, the UE is co-located with one or more other UEs of the group of UEs and the one or more offsets are in accordance with the collocation.

In some examples, a first subset of downlink control channel candidates of the one or more downlink control channel candidates share a common DMRS sequence associated with a shared DMRS. In some examples, receiving the one or more reference signals includes receiving the shared DMRS via at least one downlink control channel candidate of the first subset of downlink control channel candidates.

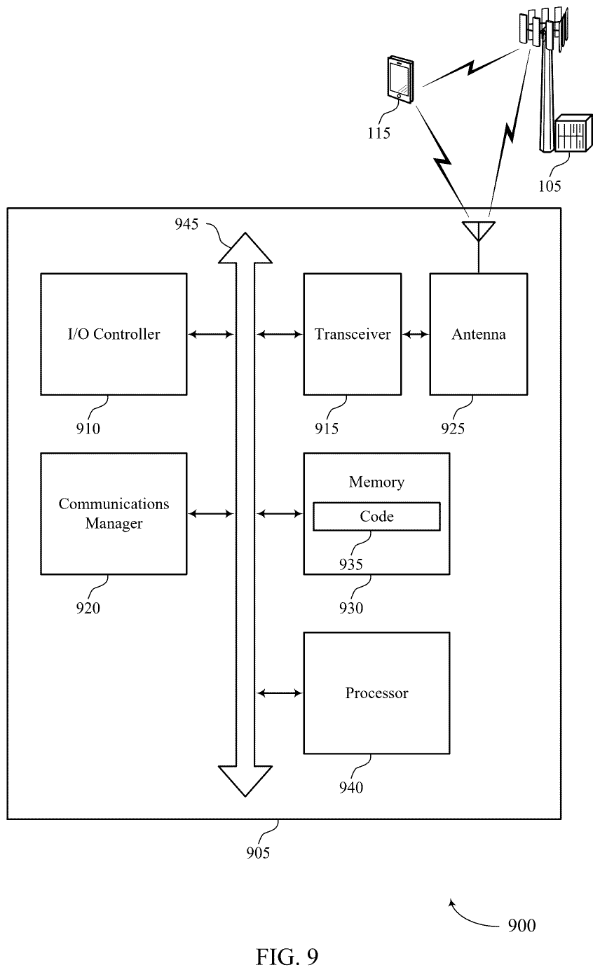

FIG. 9 shows a diagram of a system 900 including a device 905 that supports interlaced search space configuration for reference signal sharing within a wireless communications system in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting interlaced search space configuration for reference signal sharing within a wireless communications system). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The communications manager 920 is capable of, configured to, or operable to support a means for monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE. The communications manager 920 is capable of, configured to, or operable to support a means for receiving, at the one or more target CCEs, one or more reference signals in accordance with monitoring for the at least one target downlink control channel.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of interlaced search space configuration for reference signal sharing within a wireless communications system as described herein, or the at least one processor 940 and the at least one memory 930 may be otherwise configured to, individually or collectively, perform or support such operations.

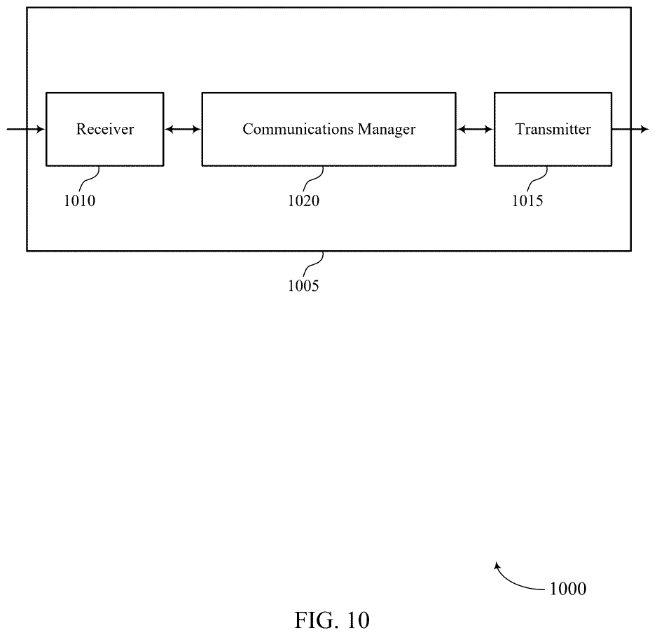

FIG. 10 shows a block diagram 1000 of a device 1005 that supports interlaced search space configuration for reference signal sharing within a wireless communications system in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of interlaced search space configuration for reference signal sharing within a wireless communications system as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The communications manager 1020 is capable of, configured to, or operable to support a means for outputting, at one or more target CCEs of the interlaced set of CCEs, one or more reference signals in accordance with the control channel configuration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced latency, and more efficient utilization of communication resources.

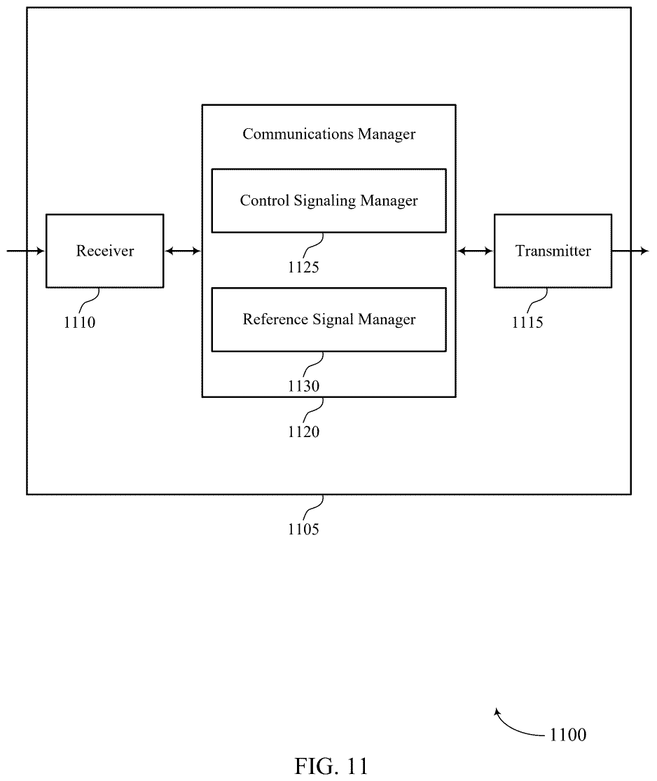

FIG. 11 shows a block diagram 1100 of a device 1105 that supports interlaced search space configuration for reference signal sharing within a wireless communications system in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of interlaced search space configuration for reference signal sharing within a wireless communications system as described herein. For example, the communications manager 1120 may include a control signaling manager 1125 a reference signal manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The control signaling manager 1125 is capable of, configured to, or operable to support a means for outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The reference signal manager 1130 is capable of, configured to, or operable to support a means for outputting, at one or more target CCEs of the interlaced set of CCEs, one or more reference signals in accordance with the control channel configuration.

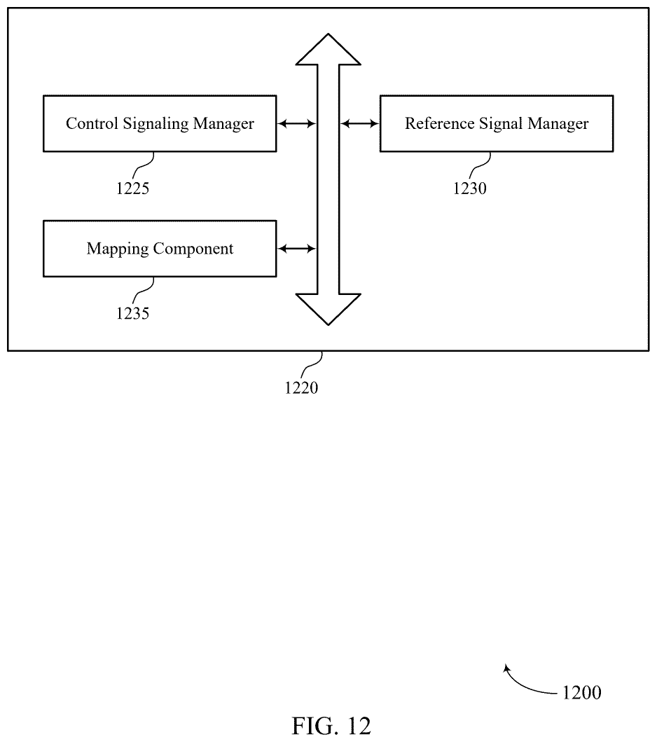

FIG. 12 shows a block diagram 1200 of a communications manager 1220 that supports interlaced search space configuration for reference signal sharing within a wireless communications system in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of interlaced search space configuration for reference signal sharing within a wireless communications system as described herein. For example, the communications manager 1220 may include a control signaling manager 1225, a reference signal manager 1230, a mapping component 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The control signaling manager 1225 is capable of, configured to, or operable to support a means for outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The reference signal manager 1230 is capable of, configured to, or operable to support a means for outputting, at one or more target CCEs of the interlaced set of CCEs, one or more reference signals in accordance with the control channel configuration.

In some examples, the mapping component 1235 is capable of, configured to, or operable to support a means for mapping the one or more downlink control channel candidates to the interlaced set of CCEs in accordance with a CCE group index, a CCE index, or both, in accordance with the one or more offsets, where outputting the one or more reference signals at the one or more target CCEs is in accordance with mapping the one or more downlink control channel candidates to the interlaced set of CCEs.

In some examples, the mapping component 1235 is capable of, configured to, or operable to support a means for mapping the one or more downlink control channel candidates to a set of multiple sets of CCEs in accordance with the one or more offsets, an aggregation level, or both, where the set of multiple sets of CCEs includes at least the interlaced set of CCEs, where outputting the one or more reference signals at the one or more target CCEs is in accordance with mapping the one or more downlink control channel candidates to the set of multiple sets of CCEs.

In some examples, a quantity of sets of CCEs within the set of multiple sets of CCEs is in accordance with the aggregation level.

In some examples, the one or more downlink control channel candidates include a quantity of downlink control channel candidates, the quantity of downlink control channel candidates in accordance with a quantity of sets of CCEs within the set of multiple sets of CCEs.

In some examples, the control channel configuration indicates that each downlink control channel candidate of the one or more downlink control channel candidates is associated with a respective consecutive index.

In some examples, the mapping component 1235 is capable of, configured to, or operable to support a means for mapping the one or more downlink control channel candidates to the interlaced set of CCEs in accordance with the respective consecutive index and a quantity of groups of CCEs in the interlaced set of CCEs, where outputting the one or more reference signals at the one or more target CCEs is in accordance with mapping the one or more downlink control channel candidates to the interlaced set of CCEs.

In some examples, the mapping component 1235 is capable of, configured to, or operable to support a means for mapping the one or more downlink control channel candidates to the interlaced set of CCEs in accordance with the respective consecutive index and a respective interlace index, the respective interlace index indicated in the control channel configuration, where outputting the one or more reference signals at the one or more target CCEs is in accordance with mapping the one or more downlink control channel candidates to the interlaced set of CCEs.

In some examples, to support outputting the one or more reference signals, the reference signal manager 1230 is capable of, configured to, or operable to support a means for outputting, via at least one downlink control channel candidate, the one or more reference signals to the group of UEs in accordance with the control channel configuration mapping the at least one downlink control channel candidate to the interlaced set of CCEs.

In some examples, the control channel configuration indicates that each downlink control channel candidate of the one or more downlink control channel candidates is associated with a respective leading CCE associated with a respective leading CCE index. In some examples, each downlink control channel candidate of the one or more downlink control channel candidates is associated with a respective leading CCE index in accordance with the leading CCE index.

In some examples, the mapping component 1235 is capable of, configured to, or operable to support a means for mapping the one or more downlink control channel candidates to the interlaced set of CCEs in accordance with a quantity of CCEs in the interlaced set of CCEs and a quantity of groups of CCEs in the interlaced set of CCEs, where outputting the one or more reference signals at the one or more target CCEs is in accordance with mapping the one or more downlink control channel candidates to the interlaced set of CCEs.

In some examples, the mapping component 1235 is capable of, configured to, or operable to support a means for mapping the one or more downlink control channel candidates to the interlaced set of CCEs in accordance with the respective leading CCE index and a quantity of CCEs in the interlaced set of CCEs, where outputting the one or more reference signals at the one or more target CCEs is in accordance with mapping the one or more downlink control channel candidates to the interlaced set of CCEs.

In some examples, to support outputting the one or more reference signals, the reference signal manager 1230 is capable of, configured to, or operable to support a means for outputting, via at least one downlink control channel candidate, the one or more reference signals to the group of UEs in accordance with the mapping associated with the respective leading CCE.

In some examples, a UE of the group of UEs is co-located with one or more other UEs of the group of UEs and the one or more offsets are in accordance with the collocation.

In some examples, a first subset of downlink control channel candidates of the one or more downlink control channel candidates share a common DMRS sequence associated with a shared DMRS. In some examples, outputting the one or more reference signals includes outputting the shared DMRS via at least one downlink control channel candidate of the first subset of downlink control channel candidates.

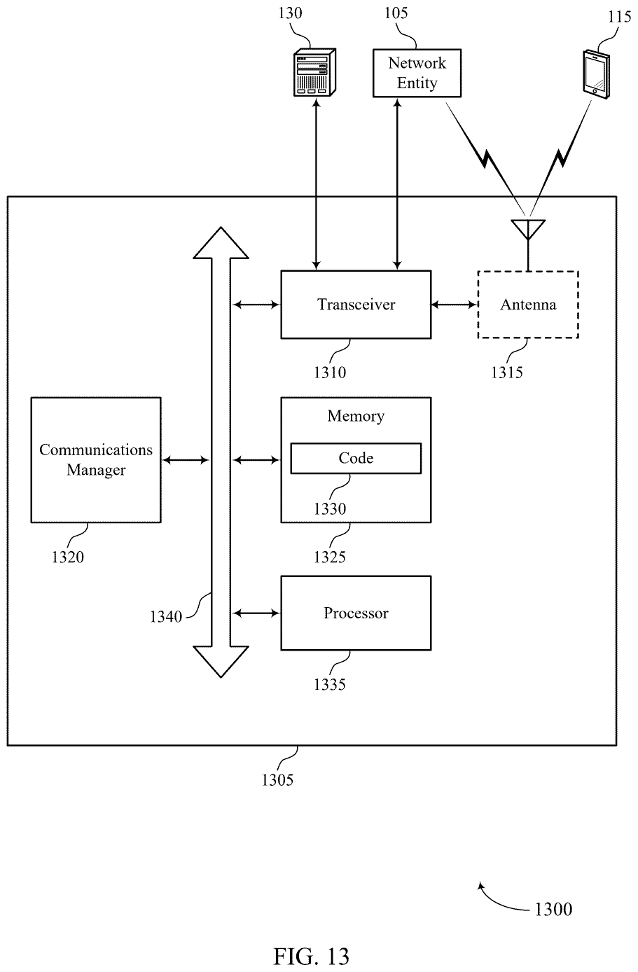

FIG. 13 shows a diagram of a system 1300 including a device 1305 that supports interlaced search space configuration for reference signal sharing within a wireless communications system in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting interlaced search space configuration for reference signal sharing within a wireless communications system). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The communications manager 1320 is capable of, configured to, or operable to support a means for outputting, at one or more target CCEs of the interlaced set of CCEs, one or more reference signals in accordance with the control channel configuration.

By including or configuring the communications manager 1320 in accordance with examples as described herein, the device 1305 may support techniques for improved communication reliability, reduced latency, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of interlaced search space configuration for reference signal sharing within a wireless communications system as described herein, or the at least one processor 1335 and the at least one memory 1325 may be otherwise configured to, individually or collectively, perform or support such operations.

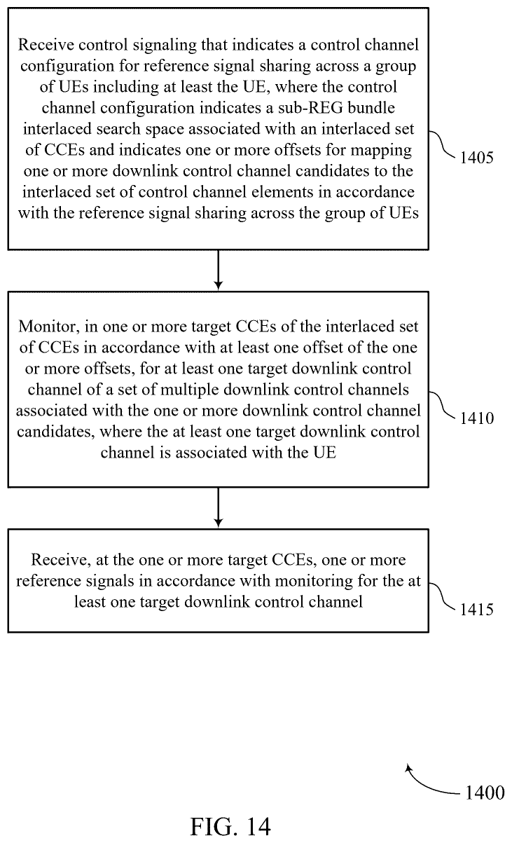

FIG. 14 shows a flowchart illustrating a method 1400 that supports interlaced search space configuration for reference signal sharing within a wireless communications system in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The operations of 1405 may be performed in accordance with examples as disclosed herein. In some examples, aspects of the operations of 1405 may be performed by a control signaling manager 825 as described with reference to FIG. 8.

At 1410, the method may include monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE. The operations of 1410 may be performed in accordance with examples as disclosed herein. In some examples, aspects of the operations of 1410 may be performed by a PDCCH monitoring component 830 as described with reference to FIG. 8.

At 1415, the method may include receiving, at the one or more target CCEs, one or more reference signals in accordance with monitoring for the at least one target downlink control channel. The operations of 1415 may be performed in accordance with examples as disclosed herein. In some examples, aspects of the operations of 1415 may be performed by a reference signal manager 835 as described with reference to FIG. 8.

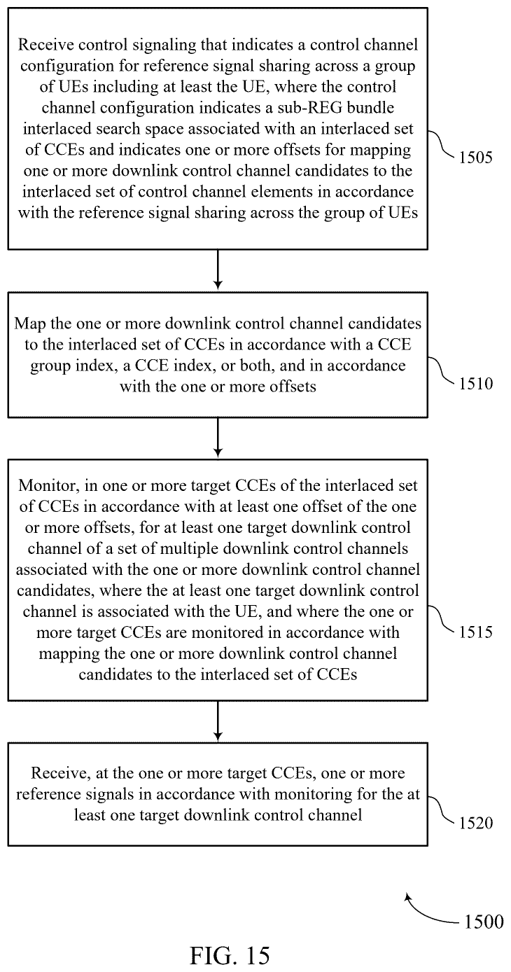

FIG. 15 shows a flowchart illustrating a method 1500 that supports interlaced search space configuration for reference signal sharing within a wireless communications system in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving control signaling that indicates a control channel configuration for reference signal sharing across a group of UEs including at least the UE, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The operations of 1505 may be performed in accordance with examples as disclosed herein. In some examples, aspects of the operations of 1505 may be performed by a control signaling manager 825 as described with reference to FIG. 8.

At 1510, the method may include mapping the one or more downlink control channel candidates to the interlaced set of CCEs in accordance with a CCE group index, a CCE index, or both, and in accordance with the one or more offsets. The operations of 1510 may be performed in accordance with examples as disclosed herein. In some examples, aspects of the operations of 1510 may be performed by a mapping component 840 as described with reference to FIG. 8.

At 1515, the method may include monitoring, in one or more target CCEs of the interlaced set of CCEs in accordance with at least one offset of the one or more offsets, for at least one target downlink control channel of a set of multiple downlink control channels associated with the one or more downlink control channel candidates, where the at least one target downlink control channel is associated with the UE, and where the one or more target CCEs are monitored in accordance with mapping the one or more downlink control channel candidates to the interlaced set of CCEs. The operations of 1515 may be performed in accordance with examples as disclosed herein. In some examples, aspects of the operations of 1515 may be performed by a PDCCH monitoring component 830 as described with reference to FIG. 8.

At 1520, the method may include receiving, at the one or more target CCEs, one or more reference signals in accordance with monitoring for the at least one target downlink control channel. The operations of 1520 may be performed in accordance with examples as disclosed herein. In some examples, aspects of the operations of 1520 may be performed by a reference signal manager 835 as described with reference to FIG. 8.

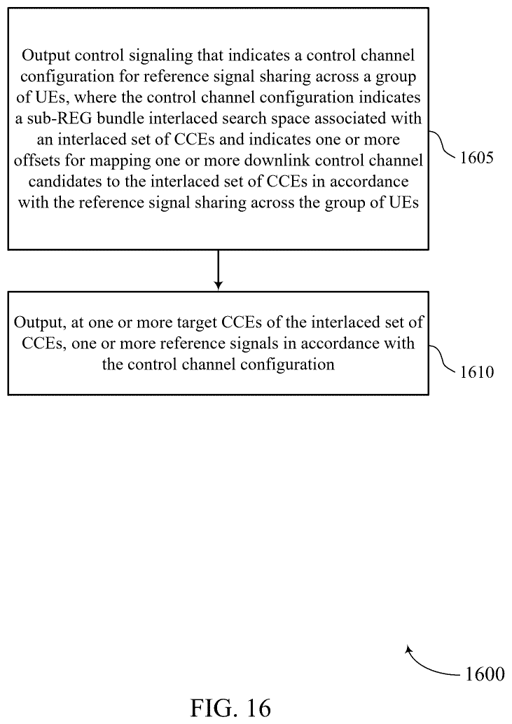

FIG. 16 shows a flowchart illustrating a method 1600 that supports interlaced search space configuration for reference signal sharing within a wireless communications system in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting control signaling that indicates a control channel configuration for reference signal sharing across a group of UEs, where the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs. The operations of 1605 may be performed in accordance with examples as disclosed herein. In some examples, aspects of the operations of 1605 may be performed by a control signaling manager 1225 as described with reference to FIG. 12.

At 1610, the method may include outputting, at one or more target CCEs of the interlaced set of CCEs, one or more reference signals in accordance with the control channel configuration. The operations of 1610 may be performed in accordance with examples as disclosed herein. In some examples, aspects of the operations of 1610 may be performed by a reference signal manager 1230 as described with reference to FIG. 12.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:

Aspect 1: A method for wireless communications at a UE, comprising: receiving control signaling that indicates a control channel configuration for reference signal sharing across a group of UEs comprising at least the UE, wherein the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs; monitoring, in one or more target CCEs of the interlaced set of CCEs in accordance with at least one offset of the one or more offsets, for at least one target downlink control channel of a plurality of downlink control channels associated with the one or more downlink control channel candidates, wherein the at least one target downlink control channel is associated with the UE; and receiving, at the one or more target CCEs, one or more reference signals in accordance with monitoring for the at least one target downlink control channel.

Aspect 2: The method of aspect 1, further comprising: mapping the one or more downlink control channel candidates to the interlaced set of CCEs in accordance with a CCE group index, a CCE index, or both, and in accordance with the one or more offsets, wherein the one or more target CCEs are monitored in accordance with mapping the one or more downlink control channel candidates to the interlaced set of CCEs.

Aspect 3: The method of any of aspects 1 through 2, further comprising: mapping the one or more downlink control channel candidates to a plurality of sets of CCEs in accordance with the one or more offsets, an aggregation level, or both, wherein the plurality of sets of CCEs comprises at least the interlaced set of CCEs and wherein the one or more target CCEs are monitored in accordance with mapping the one or more downlink control channel candidates to the plurality of sets of CCEs.

Aspect 4: The method of aspect 3, wherein a quantity of sets of CCEs in the plurality of sets of CCEs is in accordance with the aggregation level.

Aspect 5: The method of any of aspects 3 through 4, wherein the one or more downlink control channel candidates comprise a quantity of downlink control channel candidates, the quantity of downlink control channel candidates in accordance with a quantity of sets of CCEs within the plurality of sets of CCEs.

Aspect 6: The method of any of aspects 1 through 5, wherein the control channel configuration indicates that each downlink control channel candidate of the one or more downlink control channel candidates is associated with a respective consecutive index.

Aspect 7: The method of aspect 6, further comprising: mapping the one or more downlink control channel candidates to the interlaced set of CCEs in accordance with the respective consecutive index and a quantity of groups of CCEs in the interlaced set of CCEs, wherein the one or more target CCEs are monitored in accordance with mapping the one or more downlink control channel candidates to the interlaced set of CCEs.

Aspect 8: The method of any of aspects 6 through 7, further comprising: mapping the one or more downlink control channel candidates to the interlaced set of CCEs in accordance with the respective consecutive index and a respective interlace index, the respective interlace index indicated in the control channel configuration, wherein the one or more target CCEs are monitored in accordance with mapping the one or more downlink control channel candidates to the interlaced set of CCEs.

Aspect 9: The method of any of aspects 1 through 5, wherein the control channel configuration indicates that each downlink control channel candidate of the one or more downlink control channel candidates is associated with a respective leading CCE associated with a respective leading CCE index, each downlink control channel candidate of the one or more downlink control channel candidates is associated with a respective CCE index in accordance with the leading CCE index.

Aspect 10: The method of aspect 9, further comprising: mapping the one or more downlink control channel candidates to the interlaced set of CCEs in accordance with the respective leading CCE index and a quantity of CCEs in the interlaced set of CCEs, wherein the one or more target CCEs are monitored in accordance with mapping the one or more downlink control channel candidates to the interlaced set of CCEs.

Aspect 11: The method of any of aspects 9 through 10, further comprising: mapping the one or more downlink control channel candidates to the interlaced set of CCEs in accordance with a quantity of CCEs in the interlaced set of CCEs and a quantity of groups of CCEs in the interlaced set of CCEs, wherein the one or more target CCEs are monitored in accordance with mapping the one or more downlink control channel candidates to the interlaced set of CCEs.

Aspect 12: The method of any of aspects 1 through 11, wherein the UE is co-located with one or more other UEs of the group of UEs and the one or more offsets are in accordance with the co-location.

Aspect 13: The method of any of aspects 1 through 12, wherein a first subset of downlink control channel candidates of the one or more downlink control channel candidates share a common DMRS sequence associated with a shared DMRS, and wherein receiving the one or more reference signals comprises: receiving the shared DMRS via at least one downlink control channel candidate of the first subset of downlink control channel candidates.

Aspect 14: A method for wireless communications at a network entity, comprising: outputting control signaling that indicates a control channel configuration for reference signal sharing across a group of UEs, wherein the control channel configuration indicates a sub-REG bundle interlaced search space associated with an interlaced set of CCEs and indicates one or more offsets for mapping one or more downlink control channel candidates to the interlaced set of CCEs in accordance with the reference signal sharing across the group of UEs; and outputting, at one or more target CCEs of the interlaced set of CCEs, one or more reference signals in accordance with the control channel configuration.

Aspect 15: The method of aspect 14, further comprising: mapping the one or more downlink control channel candidates to the interlaced set of CCEs in accordance with a CCE group index, a CCE index, or both, in accordance with the one or more offsets, wherein outputting the one or more reference signals at the one or more target CCEs is in accordance with mapping the one or more downlink control channel candidates to the interlaced set of CCEs.

Aspect 16: The method of any of aspects 14 through 15, further comprising: mapping the one or more downlink control channel candidates to a plurality of sets of CCEs in accordance with the one or more offsets, an aggregation level, or both, wherein the plurality of sets of CCEs comprises at least the interlaced set of CCEs, wherein outputting the one or more reference signals at the one or more target CCEs is in accordance with mapping the one or more downlink control channel candidates to the plurality of sets of CCEs.

Aspect 17: The method of aspect 16, wherein a quantity of sets of CCEs within the plurality of sets of CCEs is in accordance with the aggregation level.

Aspect 18: The method of any of aspects 16 through 17, wherein the one or more downlink control channel candidates comprise a quantity of downlink control channel candidates, the quantity of downlink control channel candidates in accordance with a quantity of sets of CCEs within the plurality of sets of CCEs.

Aspect 19: The method of any of aspects 14 through 18, wherein the control channel configuration indicates that each downlink control channel candidate of the one or more downlink control channel candidates is associated with a respective consecutive index.

Aspect 20: The method of aspect 19, further comprising: mapping the one or more downlink control channel candidates to the interlaced set of CCEs in accordance with the respective consecutive index and a quantity of groups of CCEs in the interlaced set of CCEs, wherein outputting the one or more reference signals at the one or more target CCEs is in accordance with mapping the one or more downlink control channel candidates to the interlaced set of CCEs.

Aspect 21: The method of any of aspects 19 through 20, further comprising: mapping the one or more downlink control channel candidates to the interlaced set of CCEs in accordance with the respective consecutive index and a respective interlace index, the respective interlace index indicated in the control channel configuration, wherein outputting the one or more reference signals at the one or more target CCEs is in accordance with mapping the one or more downlink control channel candidates to the interlaced set of CCEs.

Aspect 22: The method of any of aspects 19 through 21, wherein outputting the one or more reference signals comprises: outputting, via at least one downlink control channel candidate, the one or more reference signals to the group of UEs in accordance with the control channel configuration mapping the at least one downlink control channel candidate to the interlaced set of CCEs.

Aspect 23: The method of any of aspects 14 through 18, the control channel configuration indicates that each downlink control channel candidate of the one or more downlink control channel candidates is associated with a respective leading CCE associated with a respective leading CCE index, wherein each downlink control channel candidate of the one or more downlink control channel candidates is associated with a respective leading CCE index in accordance with the leading CCE index.

Aspect 24: The method of aspect 23, further comprising: mapping the one or more downlink control channel candidates to the interlaced set of CCEs in accordance with a quantity of CCEs in the interlaced set of CCEs and a quantity of groups of CCEs in the interlaced set of CCEs, wherein outputting the one or more reference signals at the one or more target CCEs is in accordance with mapping the one or more downlink control channel candidates to the interlaced set of CCEs.

Aspect 25: The method of any of aspects 23 through 24, further comprising: mapping the one or more downlink control channel candidates to the interlaced set of CCEs in accordance with the respective leading CCE index and a quantity of CCEs in the interlaced set of CCEs, wherein outputting the one or more reference signals at the one or more target CCEs is in accordance with mapping the one or more downlink control channel candidates to the interlaced set of CCEs.

Aspect 26: The method of any of aspects 23 through 25, wherein outputting the one or more reference signals comprises: outputting, via at least one downlink control channel candidate, the one or more reference signals to the group of UEs in accordance with the mapping associated with the respective leading CCE.

Aspect 27: The method of any of aspects 14 through 26, wherein a UE of the group of UEs is co-located with one or more other UEs of the group of UEs and the one or more offsets are in accordance with the co-location.

Aspect 28: The method of any of aspects 14 through 27, wherein a first subset of downlink control channel candidates of the one or more downlink control channel candidates share a common DMRS sequence associated with a shared DMRS, and wherein outputting the one or more reference signals comprises: outputting the shared DMRS via at least one downlink control channel candidate of the first subset of downlink control channel candidates.

Aspect 29: A UE for wireless communications, comprising one or more memories storing processor-executable code, and one or more processors coupled with the one or more memories and individually or collectively operable to execute the code to cause the UE to perform a method of any of aspects 1 through 13.

Aspect 30: A UE for wireless communications, comprising at least one means for performing a method of any of aspects 1 through 13.

Aspect 31: A non-transitory computer-readable medium storing code for wireless communications, the code comprising instructions executable by one or more processors to perform a method of any of aspects 1 through 13.

Aspect 32: A network entity for wireless communications, comprising one or more memories storing processor-executable code, and one or more processors coupled with the one or more memories and individually or collectively operable to execute the code to cause the network entity to perform a method of any of aspects 14 through 28.

Aspect 33: A network entity for wireless communications, comprising at least one means for performing a method of any of aspects 14 through 28.

Aspect 34: A non-transitory computer-readable medium storing code for wireless communications, the code comprising instructions executable by one or more processors to perform a method of any of aspects 14 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a control channel configuration for reference signal sharing across a group of UEs comprising at least the UE, wherein the control channel configuration indicates a sub-resource element group bundle interlaced search space associated with an interlaced set of control channel elements and indicates one or more offsets for mapping one or more downlink control channel candidates to the interlaced set of control channel elements in accordance with the reference signal sharing across the group of UEs;
monitor, in one or more target control channel elements of the interlaced set of control channel elements in accordance with at least one offset of the one or more offsets, for at least one target downlink control channel of a plurality of downlink control channels associated with the one or more downlink control channel candidates, wherein the at least one target downlink control channel is associated with the UE; and
receive, at the one or more target control channel elements, one or more reference signals in accordance with monitoring for the at least one target downlink control channel.

2. The UE of claim 1, wherein the one or more processors are individually or collectively further operable to execute the code to cause the UE to:
map the one or more downlink control channel candidates to the interlaced set of control channel elements in accordance with a control channel element group index, a control channel element index, or both, and in accordance with the one or more offsets, wherein the one or more target control channel elements are monitored in accordance with mapping the one or more downlink control channel candidates to the interlaced set of control channel elements.

3. The UE of claim 1, wherein the one or more processors are individually or collectively further operable to execute the code to cause the UE to:
map the one or more downlink control channel candidates to a plurality of sets of control channel elements in accordance with the one or more offsets, an aggregation level, or both, wherein the plurality of sets of control channel elements comprises at least the interlaced set of control channel elements and wherein the one or more target control channel elements are monitored in accordance with mapping the one or more downlink control channel candidates to the plurality of sets of control channel elements.

4. The UE of claim 3, wherein a quantity of sets of control channel elements in the plurality of sets of control channel elements is in accordance with the aggregation level.

5. The UE of claim 3, wherein the one or more downlink control channel candidates comprise a quantity of downlink control channel candidates, the quantity of downlink control channel candidates in accordance with a quantity of sets of control channel elements within the plurality of sets of control channel elements.

6. The UE of claim 1, wherein the control channel configuration indicates that each downlink control channel candidate of the one or more downlink control channel candidates is associated with a respective consecutive index.

7. The UE of claim 6, wherein the one or more processors are individually or collectively further operable to execute the code to cause the UE to:
map the one or more downlink control channel candidates to the interlaced set of control channel elements in accordance with the respective consecutive index and a quantity of groups of control channel elements in the interlaced set of control channel elements, wherein the one or more target control channel elements are monitored in accordance with mapping the one or more downlink control channel candidates to the interlaced set of control channel elements.

8. The UE of claim 6, wherein the one or more processors are individually or collectively further operable to execute the code to cause the UE to:
map the one or more downlink control channel candidates to the interlaced set of control channel elements in accordance with the respective consecutive index and a respective interlace index, the respective interlace index indicated in the control channel configuration, wherein the one or more target control channel elements are monitored in accordance with mapping the one or more downlink control channel candidates to the interlaced set of control channel elements.

9. The UE of claim 1, wherein the control channel configuration indicates that each downlink control channel candidate of the one or more downlink control channel candidates is associated with a respective leading control channel element associated with a respective leading control channel element index, wherein each downlink control channel candidate of the one or more downlink control channel candidates is associated with a respective control channel element index in accordance with the leading control channel element index.

10. The UE of claim 9, wherein the one or more processors are individually or collectively further operable to execute the code to cause the UE to:
map the one or more downlink control channel candidates to the interlaced set of control channel elements in accordance with the respective leading control channel element index and a quantity of control channel elements in the interlaced set of control channel elements, wherein the one or more target control channel elements are monitored in accordance with mapping the one or more downlink control channel candidates to the interlaced set of control channel elements.

11. The UE of claim 9, wherein the one or more processors are individually or collectively further operable to execute the code to cause the UE to:
map the one or more downlink control channel candidates to the interlaced set of control channel elements in accordance with a quantity of control channel elements in the interlaced set of control channel elements and a quantity of groups of control channel elements in the interlaced set of control channel elements, wherein the one or more target control channel elements are monitored in accordance with mapping the one or more downlink control channel candidates to the interlaced set of control channel elements.

12. The UE of claim 1, wherein the UE is co-located with one or more other UEs of the group of UEs and the one or more offsets are in accordance with the co-location.

13. The UE of claim 1, wherein a first subset of downlink control channel candidates of the one or more downlink control channel candidates share a common demodulation reference signal (DMRS) sequence associated with a shared DMRS, and wherein, to receive the one or more reference signals, the one or more processors are individually or collectively further operable to execute the code to cause the UE to:
receive the shared DMRS via at least one downlink control channel candidate of the first subset of downlink control channel candidates.

14. A network entity, comprising:
one or more memories storing processor-executable code; and
one or more processors coupled with the one or more memories and individually or collectively operable to execute the code to cause the network entity to:
output control signaling that indicates a control channel configuration for reference signal sharing across a group of user equipments (UEs), wherein the control channel configuration indicates a sub-resource element group bundle interlaced search space associated with an interlaced set of control channel elements and indicates one or more offsets for mapping one or more downlink control channel candidates to the interlaced set of control channel elements in accordance with the reference signal sharing across the group of UEs; and
output, at one or more target control channel elements of the interlaced set of control channel elements, one or more reference signals in accordance with the control channel configuration.

15. The network entity of claim 14, wherein the one or more processors are individually or collectively further operable to execute the code to cause the network entity to:
map the one or more downlink control channel candidates to the interlaced set of control channel elements in accordance with a control channel element group index, a control channel element index, or both, in accordance with the one or more offsets, wherein outputting the one or more reference signals at the one or more target control channel elements is in accordance with mapping the one or more downlink control channel candidates to the interlaced set of control channel elements.

16. The network entity of claim 14, wherein the one or more processors are individually or collectively further operable to execute the code to cause the network entity to:
map the one or more downlink control channel candidates to a plurality of sets of control channel elements in accordance with the one or more offsets, an aggregation level, or both, wherein the plurality of sets of control channel elements comprises at least the interlaced set of control channel elements, wherein outputting the one or more reference signals at the one or more target control channel elements is in accordance with mapping the one or more downlink control channel candidates to the plurality of sets of control channel elements.

17. The network entity of claim 16, wherein a quantity of sets of control channel elements within the plurality of sets of control channel elements is in accordance with the aggregation level.

18. The network entity of claim 16, wherein the one or more downlink control channel candidates comprise a quantity of downlink control channel candidates, the quantity of downlink control channel candidates in accordance with a quantity of sets of control channel elements within the plurality of sets of control channel elements.

19. The network entity of claim 14, wherein the control channel configuration indicates that each downlink control channel candidate of the one or more downlink control channel candidates is associated with a respective consecutive index.

20. The network entity of claim 19, wherein the one or more processors are individually or collectively further operable to execute the code to cause the network entity to:
map the one or more downlink control channel candidates to the interlaced set of control channel elements in accordance with the respective consecutive index and a quantity of groups of control channel elements in the interlaced set of control channel elements, wherein outputting the one or more reference signals at the one or more target control channel elements is in accordance with mapping the one or more downlink control channel candidates to the interlaced set of control channel elements.

21. The network entity of claim 19, wherein the one or more processors are individually or collectively further operable to execute the code to cause the network entity to:
map the one or more downlink control channel candidates to the interlaced set of control channel elements in accordance with the respective consecutive index and a respective interlace index, the respective interlace index indicated in the control channel configuration, wherein outputting the one or more reference signals at the one or more target control channel elements is in accordance with mapping the one or more downlink control channel candidates to the interlaced set of control channel elements.

22. The network entity of claim 19, wherein, to output the one or more reference signals, the one or more processors are individually or collectively operable to execute the code to cause the network entity to:
output, via at least one downlink control channel candidate, the one or more reference signals to the group of UEs in accordance with the control channel configuration mapping the at least one downlink control channel candidate to the interlaced set of control channel elements.

23. The network entity of claim 14, wherein the control channel configuration indicates that each downlink control channel candidate of the one or more downlink control channel candidates is associated with a respective leading control channel element associated with a respective leading control channel element index, wherein each downlink control channel candidate of the one or more downlink control channel candidates is associated with a respective leading control channel element index in accordance with the leading control channel element index.

24. The network entity of claim 23, wherein the one or more processors are individually or collectively further operable to execute the code to cause the network entity to:
map the one or more downlink control channel candidates to the interlaced set of control channel elements in accordance with a quantity of control channel elements in the interlaced set of control channel elements and a quantity of groups of control channel elements in the interlaced set of control channel elements, wherein outputting the one or more reference signals at the one or more target control channel elements is in accordance with mapping the one or more downlink control channel candidates to the interlaced set of control channel elements.

25. The network entity of claim 23, wherein the one or more processors are individually or collectively further operable to execute the code to cause the network entity to:
map the one or more downlink control channel candidates to the interlaced set of control channel elements in accordance with the respective leading control channel element index and a quantity of control channel elements in the interlaced set of control channel elements, wherein outputting the one or more reference signals at the one or more target control channel elements is in accordance with mapping the one or more downlink control channel candidates to the interlaced set of control channel elements.

26. The network entity of claim 23, wherein, to output the one or more reference signals, the one or more processors are individually or collectively operable to execute the code to cause the network entity to:
output, via at least one downlink control channel candidate, the one or more reference signals to the group of UEs in accordance with the mapping associated with the respective leading control channel element.

27. The network entity of claim 14, wherein a UE of the group of UEs is co-located with one or more other UEs of the group of UEs and the one or more offsets are in accordance with the co-location.

28. The network entity of claim 14, wherein a first subset of downlink control channel candidates of the one or more downlink control channel candidates share a common demodulation reference signal (DMRS) sequence associated with a shared DMRS, and wherein, to output the one or more reference signals, the one or more processors are individually or collectively further operable to execute the code to cause the network entity to:
output the shared DMRS via at least one downlink control channel candidate of the first subset of downlink control channel candidates.

29. A method for wireless communications at a user equipment (UE), comprising:
receiving control signaling that indicates a control channel configuration for reference signal sharing across a group of UEs comprising at least the UE, wherein the control channel configuration indicates a sub-resource element group bundle interlaced search space associated with an interlaced set of control channel elements and indicates one or more offsets for mapping one or more downlink control channel candidates to the interlaced set of control channel elements in accordance with the reference signal sharing across the group of UEs;
monitoring, in one or more target control channel elements of the interlaced set of control channel elements in accordance with at least one offset of the one or more offsets, for at least one target downlink control channel of a plurality of downlink control channels associated with the one or more downlink control channel candidates, wherein the at least one target downlink control channel is associated with the UE; and
receiving, at the one or more target control channel elements, one or more reference signals in accordance with monitoring for the at least one target downlink control channel.

30. A method for wireless communications at a network entity, comprising:
outputting control signaling that indicates a control channel configuration for reference signal sharing across a group of user equipments (UEs), wherein the control channel configuration indicates a sub-resource element group bundle interlaced search space associated with an interlaced set of control channel elements and indicates one or more offsets for mapping one or more downlink control channel candidates to the interlaced set of control channel elements in accordance with the reference signal sharing across the group of UEs; and
outputting, at one or more target control channel elements of the interlaced set of control channel elements, one or more reference signals in accordance with the control channel configuration.
